(19) United States
(12) Patent Application Publication
(10) Pub. No.: US 2025/0313517 A1
(43) Pub. Date: Oct. 9, 2025

(54) CARBON-NEGATIVE FERTILIZER AND METHODS FOR MAKING

(71) Applicant: William A. Hastings, Wasilla, AK (US)

(72) Inventor: William A. Hastings, Wasilla, AK (US)

(21) Appl. No.: 19/083,054

(22) Filed: Mar. 18, 2025

Related U.S. Application Data
(60) Provisional application No. 63/566,659, filed on Mar. 18, 2024.

(51) Int. Cl. C05F 17/20; C05F 17/10

(52) U.S. Cl. CPC C05F 17/20; C05F 17/15

(57) ABSTRACT

Disclosed are methods for fermenting plants with homofermentative lactic acid bacteria. The methods can be carbon neutral or carbon negative. The fermented plants can be used as a fertilizer. The plants can be root vegetables, including turnips.

This application claims the benefit of and priority to U.S. Provisional Application No. 63/566,659 filed on Mar. 18, 2024, the entire contents of which are incorporated herein by reference.

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### BACKGROUND

Fertilizers generally enhance growth, yield, or development of a plant. Fertilizers can accelerate, increase, and the like, of plant growth, yield, development, and the like. Use of fertilizers in agriculture is well established. Fertilizers are generally produced via industrial chemical and mining processes, or are produced organically via manure waste, composts, or fermentations of organic matter (usually wastes).

Today, there is good understanding that the primary nutrient components necessary for vegetation growth include what are referred to as “plant accessible” nitrogen, phosphorus, and potassium (referenced as N-P-K, respectively). These plant accessible elements can be in solubilized and/or mineralized form, the molecules lack carbon and are classified as inorganic. Organic forms of N-P-K are generally not plant accessible. It is in their soluble/mineralized inorganic forms that these elements can be accessible for use by plants.

For industrial produced N-P-K fertilizers, there can be different processes for producing the chemical components. Industrially created nitrogen fertilizers can be produced using the Haber-Bosch process, which uses large amounts of methane, high temperatures and high pressures to extract atmospheric nitrogen and combine it with hydrogen to form ammonia and other nitrates. Phosphorus is a finite element when in soluble, plant available form. The sources of phosphorus worldwide are being depleted at a high rate. Phosphorus used in fertilizers primarily comes from deposits of high, inorganic phosphate-bearing rock that took millions of years to form. Phosphorus is considered the second most limiting nutrient, after nitrogen, for plants. Potassium, the third element, also uses a great deal of mechanization to extract and process, but the supplies are more varied and in greater amounts. The advent and development of industrially produced chemical N-P-K fertilizers enabled what has been referred to as the “Green Revolution”, boosting agricultural output to keep pace with increasing population growth and ever decreasing agriculturally available land.

The benefits of industrially produced fertilizers are numerous, but they are not without costs. Industrially produced fertilizers can be capital and energy intensive to produce and, in the case of mineralized phosphorus, can rely on the continued existence and access to a finite supply of raw material.

In addition to the energy expended to produce these fertilizers, the processes also release large quantities of waste carbon dioxide gas (and other trace gases). It is estimated that industrially produced nitrogen fertilizers contribute 2.1% of global greenhouse gas emissions. Additionally, nitrogen and phosphorus fertilizers can be delivered to excess by farmers, wasting valuable, expensive, and finite (especially phosphorus) fertilizers and contributing to runoff and algae blooms. Furthermore, industrially produced fertilizers do not contain carbon and do not directly aid in construction of soil organic matter. Organic matter, high in carbon, promotes growth of microbes and fungi which are needed for plant growth.

In contrast to industrially produced fertilizers, organic N-P-K fertilizers and soil amendments, can contain decomposing organic matter, such as manure or waste organic matter that have carbon, and can contribute to existing soil organic matter. Organic N-P-K fertilizers can also have soluble/mineralized N-P-K (“plant accessible” or “soluble” N-P-K), the latter generally generated by microbes from inaccessible, organic forms. Amounts of N-P-K delivered by organic, non-manure fertilizers and composts is generally low and can be inconsistent.

Manure is currently the largest commercial source of organically-produced fertilizer and has plant-sufficient levels of inorganic plant-available N-P-K. It also has high amounts of carbon, which can be useful and essential for building soil organic capacity. Soil organic capacity helps in creating a healthy biome for beneficial bacteria necessary for plant development, growth, and yield, as well as improving the water-carrying capacity of the soil.

Manure has several drawbacks as a fertilizer. On a microbial level, it can contain dangerous pathogens which contaminate the soil and crops from which the manure is meant to promote. Additionally, manure is difficult to capture, inject, and incorporate into soil, requiring expensive catchment systems and manure application equipment. Usually, manure-as-fertilizer is limited to use within localized crop production areas near feedlots, where manure can be more easily captured and processed. Finally, manure production (and aerobic composting and/or aerobic fermentations) results in the release of large amounts of methane and carbon dioxide waste gases.

Organic fertilizers produced from waste organic matter, other than manure, have similar issues. The organic waste is first collected and transported to a facility for processing. This involves infrastructure and is capital intensive. Amounts of N-P-K can be inconsistent.

In addition to adding nutrients, in the form of soluble, plant-accessible N-P-K, there are newer and more innovative methods to add microbes and/or organic acids directly to the soil, to convert the organic N-P-K compounds already resident in the soil, but trapped in plant-unavailable forms, into soluble, plant-available N-P-K nutrients. This includes inoculating the soil with phosphorus solubilizing bacteria (PSB), potassium solubilizing bacteria (KSB), and/or add organic acids such as lactic acid. Both standard industrially produced chemical fertilizers and manure lack the ability to activate soil resident organic N, P, and K and convert them to solubilized, plant accessible nutrients.

There is a need for additional fertilizers that can be sustainably produced.

There is a need for industrial chemical processes, that result in the removal and sequestration of carbon dioxide from the atmosphere, and result in maximum oxygen conservation.

There is a need for fertilizers that can add nutrient, add soil organic matter/carbon, and convert N, P, and K organic nutrients, already resident within the soil, into plant-available inorganic N, P, and K, heretofore referred to as soil “nutrient boosting”.

There is a need for biochemical products (such as fertilizers), which can be produced without negatively impacting the food supply, or have opportunity costs against other agricultural products.

### SUMMARY

Disclosed herein are carbon-neutral (carbon negative) processes for fermenting raw, fresh plants or fresh, raw plant materials (e.g. leaves or non-woody stems or roots or combinations of each) into an organic fertilizer with soil “nutrient boosting” capabilities. In some embodiments, the plants or plant materials are fermented using homofermentative lactic acid bacteria. These bacteria do not release carbon dioxide, nor do they consume oxygen. In some embodiments, plants (e.g., root vegetables, be they root+leaf, leaf-only, root-only or non-woody stems of plants) are fermented using homofermentative lactic-acid bacteria. In some embodiments, undesirable plants (i.e. “weeds”) are fermented using homofermentative bacteria. In some embodiments, starter or inoculant cultures of homofermentative lactic-acid bacteria are added at the beginning of a fermentation. In some embodiments, diluted simple sugars (e.g. sucrose, glucose, fructose) are added at the beginning of a fermentation to aid lactic acid bacteria. In some embodiments, fermentation conditions selectively promote growth of homofermentative lactic-acid bacteria. In some embodiments, both heterofermentative and homofermentative bacteria are used to promote both lactic and acetic acid, with acetic acid being a useful and effective quick-kill broadleaf contact herbicide. In some embodiments, PSB and/or KSB bacteria are encouraged or added to help promote a more effective solubilization of organic nutrients within the fermenting plant material. The methods outlined within this application, result in a unique and novel method to produce organic fertilizers, result in a unique and novel approach to adding lactic acid as a soil-enhancing amendment, and a unique and novel approach to harnessing lactic and acetic acid fermentates as an organic herbicide. When considered in totality with the carbon-cycle, which includes the capture of carbon dioxide during photosynthesis, the overall process for this unique and novel fermentation results in a net capture and retention of atmospheric carbon dioxide, and a release of atmospheric oxygen, thereby resulting in a “carbon-negative” process.

Disclosed also herein are products of the fermentation process described above. These fermentate products can be plant fertilizers. These fermentate products can be soil amendments to solubilize resident organic phosphorus and potassium (and other nutrients) already resident within the soil in organic form, into inorganic “plant-available” phosphorus and potassium (and other nutrients). These fermentate products can be an organic herbicide.

In part, the above processes and products arise from work on fermentation of root vegetables (e.g., turnips) and the findings from that work that: i) the fermentations produce little or no gas, ii) at the completion of the fermentations, a genome analysis of bacteria in the fermentate showed a significant presence of homofermentative lactic acid bacteria and iii) the fermentations produced a fertilizer substance, similar in composition to liquid manures, without the production of methane and minimal to zero production of CO₂.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIG. 1A-C illustrates examples of harvested and shredded turnips.

FIG. 2A-B illustrates examples of turnip fermentate.

FIG. 3A-B illustrates another example of turnip fermentate.

FIG. 4 illustrates properties of example animal manure. From MARC 2008. Manure Application Rate Calculator software for Manitoba, Manitoba Agriculture, Food and Rural Initiatives. ²For pig manure data by operation type with and without phytase use, see the Farm Practices Guidelines for Pid Producers in Manitoba, Manitoba Agriculture, Food and Rural Initiatives, April 2007.

FIG. 5A-B illustrates a spreadsheet version of the online calculator, using results from our manure testing and fermentate fertilizer application rates.

FIG. 6A-B illustrates an example of Galeopsis tetrahit aka hemp nettle (a State of Alaska designated “noxious” weed) fermentate with and without sugar inoculant.

FIG. 7A-B illustrates an example of Chamerion angustifolium (fireweed) fermentate, with and without sugar inoculant.

FIG. 8 shows fermentation results of variations of root and weed fermentates.

FIG. 9 shows 2022-2023 manure testing results of variations of turnip and weed fermentates.

FIG. 10A-B shows 2023 example pictures of cucumber plants treated with fermentate-as-herbicide.

FIG. 11 shows carbon dioxide capture, and oxygen release, for an acre of turnips. Carbon dioxide and oxygen budgets of a plant cultural system in a CELSS—a case of cultivation of lettuce and turnips—PubMed (nih.gov), College of Agriculture, University of Osaka, Japan, 23 Oct. 2002. 1×turnip consumed 32.0 g of CO₂ in a 6-day period at days 24-30 of its life cycle (released 25.3 g of O₂, same period). One acre=174240 turnips (1 full turnip, 4 half turnips, and 4 quarter turnips per box=4 turnips per box=4*43560 squares per acre=174240 turnips). 17420×32 g=5575680 g=12292.27 lbs. Between 24-30 days=5.6 tonnes CO₂ removed. 66 days from day 24 to harvest≈if CO₂ capture is “straight line”, 55.7 tonnes/acre CO₂ removed . . . bonus of 40.8 tonnes O₂ released.

FIG. 12 shows example raw turnip root and raw turnip leaf nutrient analysis.

FIG. 13 shows a schematic of a carbon-negative process.

FIG. 14 shows the generalized process flow diagram for Fertilizer w/lactic acid soil booster, which achieves maximum carbon negative capability, using standard silage chopper or wood chipper or similar device.

FIG. 15 shows the attributes of the fermentate fertilizer, with comparisons to manure and standard chemical fertilizers.

FIG. 16A-D shows examples of plants where the fermentate was and was not used, for visual health comparison purposes. In FIG. 16A, the plants on the left was planted and grown with fermentate. The plants on the right was planted and grown without fermentate. Planting was done on Jun. 10, 2024. The photographs were taken on Jul. 29, 2024. In FIG. 16B, the plants on the left were planted and grown with fermentate, and the plants on the right were planted and grown without fermentate. Planting was done on Jun. 10, 2024. The photographs were taken on Jul. 29, 2024. In FIG. 16C, the plants on the left were planted and grown with fermentate, and the plants on the right were planted and grown without fermentate. Planting was done on Jun. 10, 2024. The photographs were taken on Jul. 29, 2024. In FIG. 16D, all plants (sunflowers) were planted at the same time (unknown planting date in 2024) and were photographed on Aug. 2, 2024. The circled plants (to left of the yardstick) were planted and grown without fermentate. The plants with the rectangle around them (to the right of the yardstick) were planted and grown with fermentate.

### DETAILED DESCRIPTION

Disclosed herein are methods of producing organic fertilizers, lactic acid soil amendments, and acetic acid broadleaf contact herbicides, produced by fermentation of plants. The end products can be produced using a common series of steps. In some embodiments, certain steps can be adjusted, depending upon whether the practitioner wants to maximize certain results (e.g. lactic acid dominance vs. a combined lactic/acetic acid product). The plant fermentations can primarily use homofermentative lactic acid bacteria, which produce little or no greenhouse gases, including little or no carbon dioxide (CO₂). Some plant fermentations use both heterofermentative and homofermentative bacteria, to encourage acetic acid production for herbicidal use, while still maintaining a fertilizer and lactic acid amendment capability. Thus, the fertilizers are produced using a carbon negative process.

Plant fermentation by microorganisms, or by multicellular organisms (mammals, insects, etc.), can produce greenhouse gases (e.g., carbon dioxide or CO₂, methane or CH₄, or nitrogen dioxide or NO₂). Disclosed herein are methods for reducing or eliminating the amount of greenhouse gases given off during anaerobic plant fermentation by lactic acid producing microorganisms. In some embodiments, greenhouse gas emission can be decreased or eliminated by fermenting the plants using homofermentative lactic acid bacteria. In some embodiments, the homofermentative lactic acid bacteria can be added to a plant fermentation (e.g., an inoculant or starter culture). In some embodiments, a fermentation can be managed in a way to increase the proportion of bacteria in a fermentation that are homofermentative (e.g., to selectively promote growth of homofermentative bacteria in a fermentation).

In some embodiments, the fermentations can be carbon negative. In some embodiments, these fermentations do not release CO₂ or release very little CO₂. In some embodiments, the fermentations that contain homofermentative lactic acid bacteria release less CO₂ than would be released if the fermentations contained bacteria that produce CO₂, which includes heterofermentative lactic acid bacteria.

In some embodiments, the homofermentative lactic acid bacteria can be Lactobacillus sakei.

In some embodiments, the fermentations can contain anaerobic nitrogen fixing, phosphorus solubilizing, and/or potassium solubilizing bacteria (PSB/KSB) bacteria. These organisms can-assist in producing plant-available elements in the fermentate.

In some embodiments, the phosphorus and potassium solubilizing bacteria can be Serratia plymuthica and Rhanella aquatilis.

Disclosed in some embodiments is a method to produce a carbon negative organic fertilizer by anaerobically fermenting fresh, raw, unprocessed plants or, fresh, raw, unprocessed plant material(s), be them terrestrial or aquatic (includes both freshwater and saltwater plants), with lactic acid producing microorganism(s). At a plant moisture level greater than 50%, with no upper limit to moisture limit, the fresh, raw, unprocessed (terrestrial or aquatic) plants or fresh, raw, unprocessed plant material(s) comprise the entire plant (leaf, root, stem), or portions of the plant (e.g. leaf-only), or combinations of the plant (e.g. leaf+stem, or leaf+root, or stem+root), and are chopped/chipped/shredded into chunks 2″ or slightly greater or slightly smaller and optionally inoculated with lactic acid producing microorganisms, and fermented in an anaerobic environment, whereby all effluents (liquids) generated from this fermentation are captured and not allowed to leach through the soil or be separated from the fermented biomass material. After 10-45 days of fermentation, the material is available for use as an organic fertilizer and, depending upon types of lactic acid producing microorganisms, used as an organic herbicide, as well as a source of carbon for use as a soil amendment, as well as a soil “nutrient booster” (e.g. phosphorus and potassium), whereby organic phosphorous and potassium resident within the soil is solubilized via excess lactic acid and (possibly) acetic acid produced from this method, once the material is spread and/or incorporated into the soil.

In some embodiments, salt is not added to the fermentation.

The products of the fermentations described here (i.e., the “fermentate”) can be used as a fertilizer to increase plant growth and/or yield, and/or to enhance soils. The fermentates can provide soluble, plant-available sources of N-P-K fertilizer for a plant, as well as a source of organic carbon amendment for soil health maintenance and enhancement. The fermentate can also be a source of lactic acid, which can solubilize organic P-K already resident within the soil, thus boosting the overall availability of plant-available nutrients. Finally, a fermentate with both homo and heterofermentative lactic acid bacteria, can provide a source of acetic acid, which is a very fast and effective contact herbicide for broadleaf plants. A fermentate with both homo and heterofermentative bacteria does not lose its efficacy in producing solubilized plant-available N-P-K but it does produce slightly less lactic acid per volume, to allow for acetic acid, and is (slightly) less carbon-negative when considered against the entirety of the process and carbon cycle. In some embodiments, the fermentates resulting from the methods disclosed here can substitute for manure-based fertilizers.

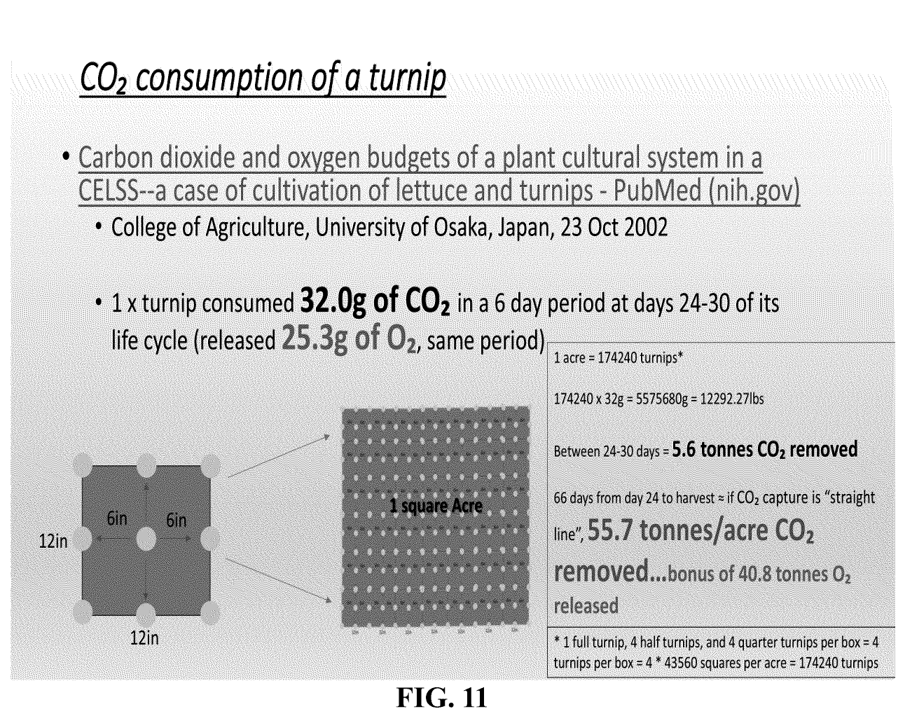

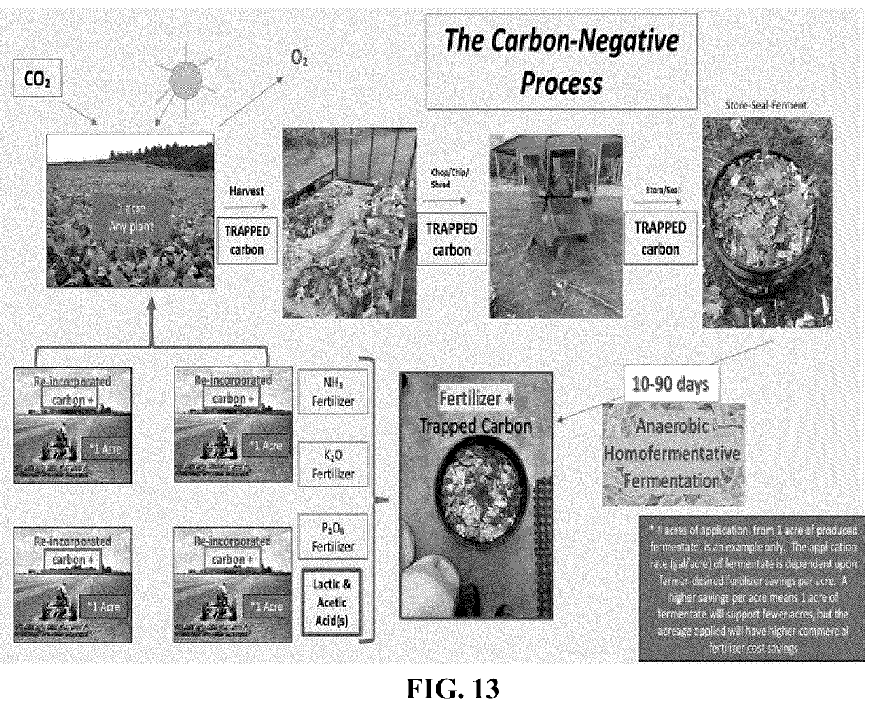

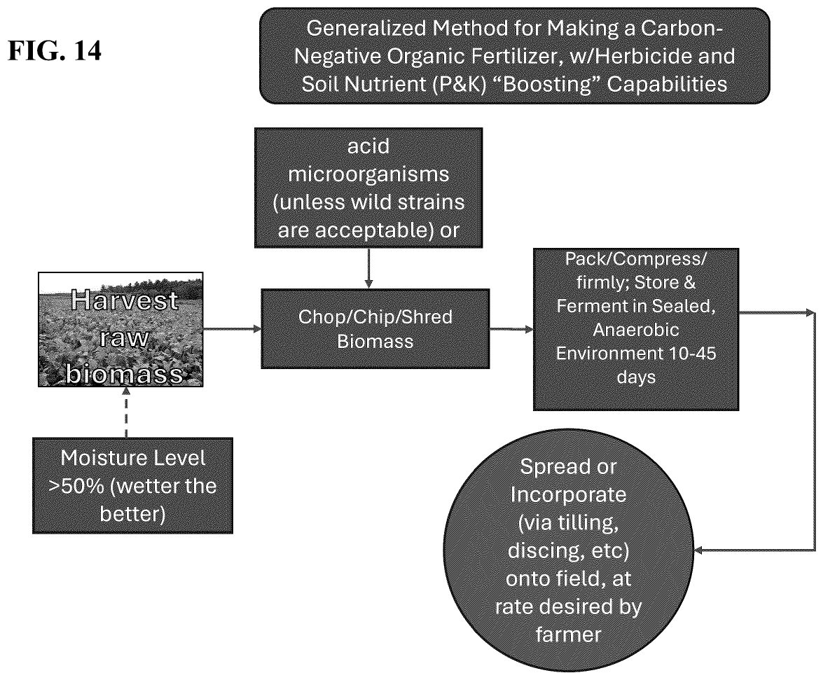

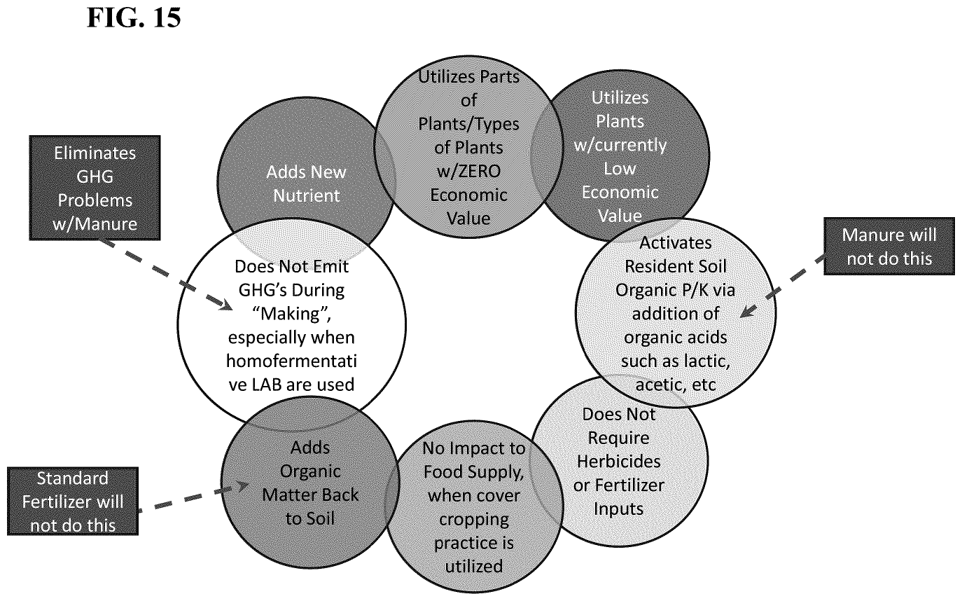

Also disclosed are methods whereby carbon captured via photosynthesis by the raw material plant substrate is retained while chemically converting the raw material plant substrate, via homofermentative anaerobic lactic acid fermentation, into a useful fertilizer and/or soil amendment and/or contact broadleaf herbicide. When only the fermentation processes disclosed here are considered, the processes can be considered carbon-neutral. However, if the time window considered includes photosynthetic growth of the plants, which removes CO₂ from the environment, the processes can be considered carbon-negative, because the carbon in CO₂ removed from the atmosphere and incorporated into the plant during photosynthesis is not released during subsequent fermentation with homofermentative bacteria. FIG. 11 illustrates the carbon dioxide capture capacity of a field of turnips. FIG. 13 illustrates the carbon negative concept and process of the fermentate method(s) and products disclosed herein.

In some embodiments, the methods disclosed here can enhance and increase the amount of soluble, plant available N-P-K resident within homofermentative effluents produced during anaerobic lactic acid fermentation by the presence of anaerobic PSB, KSB and nitrogen fixing bacteria.

In some embodiments, the methods disclosed here can facilitate removal of carbon dioxide, in quantity, from the atmosphere, and prevent carbon dioxide from being created and released during the fermentation process, thereby removing and decreasing the amount of carbon dioxide in the atmosphere.

In some embodiments, disclosed herein is a combination soluble, plant-available source of N-P-K fertilizer for a plant, as well as a source of organic carbon amendment for soil health maintenance and enhancement. The fertilizer can be from a plant substrate and can include accumulated effluent (fluids) from the fermentation process, after anaerobic fermentation via homofermentative lactic acid bacteria, homofermentative and heterofermentative lactic acid bacteria, and, optionally, anaerobic nitrogen-fixing, phosphorus solubilizing, and potassium solubilizing bacteria.

In some embodiments, the methods disclosed can create excess lactic acid which, when added to the soil, can solubilize organic P-K already resident within the soil, thereby boosting the overall availability of plant-available nutrients which the fermentate effluent contains from the fermented plant material.

In some embodiments, the methods disclosed create both lactic and acetic acid, where the acetic acid acts as a rapid-kill broadleaf contact herbicide.

Although fermentation has long been used to make silage (i.e., feed for animals), in the art, use of heterofermentative lactic acid bacteria is encouraged along with homofermentative lactic acid bacteria. Homofermentative bacteria can cause the taste of silage to be sour (low pH) and unpalatable to animals to which the silage is fed. Additionally, it is useful to add heterofermentative bacteria to encourage the later production of acetic acid, an effective mold inhibitor which, for feed silage, is a factor to preserve feed quality. The methods described herein minimize heterofermentative lactic acid bacteria and, in some embodiments, eliminate heterofermentative lactic acid bacteria. In some embodiments, the fermentate is used as a fertilizer. The methods described herein can have a variation which encourages both homo and heterofermentative bacterial growth, in order to include a herbicidal capability to the fermentate. In some embodiments, the fermentate can be used as a fertilizer, soil carbon amendment, soil lactic acid amendment, and herbicide combination.

Fermenting plants as a carbon-negative fertilizer, carbon-negative lactic acid soil amendment, and carbon-negative herbicide, is new and beneficial for several reasons: (1) this fertilizer is grown and processed deliberately; it is not converted from a waste source; (2) it harnesses bacteria that solubilize P and K and fix nitrogen by combining the bacteria with a source of organic N-P-K in a raw plant fermentate, compared to the bacteria as a soil inoculant; (3) it has the components of a dairy manure fertilizer without the risk of pathogens and without the release of CO₂ or CH₄; (4) it accomplishes the process by sequestering atmospheric carbon dioxide captured via photosynthesis and never releasing carbon dioxide during the fermentation process, effectively making the process carbon negative; (5) it can be produced and then used in any location, whereas manure fertilizer produced in animal feedlots and then limited to use in fields near these animal feedlots; (6) offers a new method of achieving a sustainable source of phosphorus to meet global agricultural demand, which heretofore has been accepted to be a finite, rapidly depleting, and irreplaceable natural resource; (7) it creates a commercial use for plants (i.e. “weeds”) that heretofore have had no commercial value and undercut agricultural productivity; (8) provides, in a single product and a single production process, at least three different organic methods (adding nutrients to soil, adding carbon to soil, adding soil “nutrient boosting” lactic acid & acetic acid to the soil) to promote plant growth; (9) has quantifiable monetary value not only in the nutrients and chemicals it produces for agricultural purposes, but also in the atmospheric carbon it captures and sequesters; (10) it offers a first-of-its-kind practical, cost-effective, and sustainable method of producing lactic acid, for the express purposes of being added to the soil to release organic phosphorus and potassium into inorganic, soluble, plant-available compounds; (11) while fermentate fertilizer can be produced from almost any plant, in some embodiments this method selects root crops and “weeds” for this task, based upon the superior growth rate and nutrient scavenging abilities of these plants, the low amounts of inputs these plants require, and their relative lack of economic competition against normal food-producing crops; and (12) in the case of root crops, this method can harness the leaf and stem as well as the root for the process, where heretofore root-crop leaves and stems have been considered a waste material and unused for any other purpose save as a carbon source for the soil, and the root is considered the only valuable resource and confined to its use as a food for humans and livestock animals.

FIG. 15 presents generalized attributes of embodiments of this method and this composition of matter vs. other standard chemical and manure fertilizers.

### Definitions

Detailed descriptions of one or more embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in any appropriate manner.

The singular forms “a”, “an” and “the” include plural reference unless the context clearly dictates otherwise. The use of the word “a” or “an” when used in conjunction with the term “comprising” in the claims and/or the specification may mean “one,” but it is also consistent with the meaning of “one or more,” “at least one,” and “one or more than one.”

Wherever any of the phrases “for example,” “such as,” “including” and the like are used herein, the phrase “and without limitation” is understood to follow unless explicitly stated otherwise. Similarly, “an example,” “exemplary” and the like are understood to be nonlimiting.

The term “substantially” allows for deviations from the descriptor that do not negatively impact the intended purpose. Descriptive terms are understood to be modified by the term “substantially” even if the word “substantially” is not explicitly recited.

The terms “comprising” and “including” and “having” and “involving” (and similarly “comprises”, “includes,” “has,” and “involves”) and the like are used interchangeably and have the same meaning. Specifically, each of the terms is defined consistent with the common United States patent law definition of “comprising” and is therefore interpreted to be an open term meaning “at least the following,” and is also interpreted not to exclude additional features, limitations, aspects, etc. Thus, for example, “a process involving steps a, b, and c” means that the process includes at least steps a, b and c. Wherever the terms “a” or “an” are used, “one or more” is understood, unless such interpretation is nonsensical in context.

The term “about” is used herein to mean approximately, roughly, around, or in the region of. When the term “about” is used in conjunction with a numerical range, it modifies that range by extending the boundaries above and below the numerical values set forth. In general, the term “about” is used herein to modify a numerical value above and below the stated value by a variance of 20 percent up or down (higher or lower).

Herein, “amendment” means a non-nutrient addition to the soil, which enhances the soil biome (such as adding carbon from the fermentate back into the soil) and/or releases organic P-K into inorganic, soluble, plant-available P-K (such as adding lactic acid into the soil).

Herein, “anaerobic” refers to “without oxygen.”

Herein, “chipping”, “shredding”, “chopping”, and the like, in relation to the plants disclosed herein, refers to an act whereby whole plants or parts thereof, are made into pieces by chipping, shredding, cutting, slicing ant the like. These processes can increase surface area of plant material, can improve ability and speed of bacteria to colonize and metabolize (i.e. ferment) the raw plant material, create a generally uniform size of material which can aid expunging of air/oxygen, release confined sugars contained within plant cell walls.

Herein, “CO₂ scavenger” can refer to a substance that can remove or sequester CO₂ from the atmosphere.

Herein, “compacting” in relation to the plants or chipped/shredded plants disclosed herein refers to applying pressure such that the plants are packed closer together.

Herein, “cover crops” refers to both a type of plant and an agricultural practice. “Cover crop” plants are listed within a USDA non-exhaustive list in TABLE 1. “Cover crops” as an agricultural practice means the planting of cover crop plants, either after harvesting the main “cash crop” of the agricultural producer, or planting and harvesting the “cover crop” before the planting of the main “cash crop” of the agricultural producer, or planting sometime within and amongst the main “cash crop” of the producer (e.g. plant corn, wait until corn has established, and then plant a cover crop in-between the corn rows). The common and usual purpose of the agricultural practice of cover crops is to utilize a fast growing, non-income generating plant to help hold soil from erosion and/or provide additional forage for livestock and/or decay into “green” manure and/or decay and improve the soil organic content of the agricultural producer's field(s).

Herein, “effluent” refers to liquids which are produced and accumulate during a fermentation process. The effluent liquids can be rich in plant-available nitrogen, phosphorus, and/or potassium. The effluents can also contain high amounts of valuable lactic and acetic acid.

Herein, “fermentate” refers to a plant mixture that is undergoing or has completed fermentation.

Herein, the term “fermentation” refers to an anaerobic process by which glucose is broken down. ATP and other compounds (e.g., lactic acid) are produced. Herein, the fermentate (e.g., the plant mixture that undergoes or has undergone fermentation) may also contain microbes that produce ATP via aerobic processes, as long as there is some anaerobic catabolismin the mixture. In some embodiments, herein, fermentation can be “to completion”, meaning that substantial additional fermentation of the available plant material, without additional processing, will not occur if the fermentation is allowed to proceed for a longer period of time.

Herein, “harvesting” refers to removing plants from the field.

Herein, “homofermentative” in relation to bacteria, refers to bacteria that do not produce CO₂ or ethanol during fermentation.

Herein, “heterofermentative” in relation to bacteria, refers to bacteria that produce CO₂ during fermentation.

Herein, “inoculant” refers to a culture of microorganisms (e.g., bacteria) that can be added, for example, to a plant at the beginning or during a fermentation. Herein, “inoculant” can also refer to glucose, sucrose, or fructose (i.e. simple sugars), possibly dissolved in water, that can be added to the chopped/chipped/shredded plants at the beginning or during a fermentation. Herein, inoculants that are added to a plant at the beginning of a fermentation can be called a “starter culture” or a “sugar source”. In some embodiments, ½ cup of sugar (e.g., brown sugar, fruit juice) can be added to 2 cups of water.

Herein, “lactic acid bacteria” or “LAB” refer to an order to gram-positive bacteria. These bacteria can produce lactic acid as a result of carbohydrate fermentation.

Herein, “vented” in reference to an airtight container in which a fermentation is occurring, refers to opening the container to release gas.

Herein, “weed” means a plant that is not deliberately planted and cultivated; a broadleaf species that is considered invasive or undesirable, for agricultural purposes.

### Plant Substrates for Fermentation, Growth of Plants, Pre-Fermentation Processing

Substrate for the fermentations disclosed here can be plants, that are directly harvested and not processed into any other substance first. In some embodiments, the substrate for the fermentations can be any plant. In some embodiments, the substrate for the fermentations disclosed herein can be plant leaves, stems, and/or roots. In some embodiments, the plant substrate has a moisture level above 50%. In some embodiments, the plant is selected for harvest and fermentation based upon plant maturity, with maturity being established from the point in time the plant sprouts and the normal growth days from that point forward, with the understanding normal growth days are affected by temperature, amount of sunlight, access to normal precipitation, and the amount of nutrients available for plant metabolism. The challenge of plant maturity is to reach a point in development where the plant offers enough moisture and sugars to enable a successful and rapid fermentation yet also has incorporated enough organic nitrogen, phosphorus, and potassium to achieve a cost-effective fermented fertilizer.

In some embodiments, the plant can be a cover crop. Per USDA, “cover crops are grasses, legumes, and other forbs that are planted for erosion control, improving soil structure, moisture, and nutrient content, increasing beneficial soil biota, suppressing weeds, providing habitat for beneficial predatory insects, facilitating crop pollinators, providing wildlife habitat, and as forage for farm animals. Furthermore, cover crops can provide energy savings both by adding nitrogen to the soil and making more soil nutrients available, thereby reducing the need to apply fertilizer” (Source: USDA, plants.usda.gov/cover-crop-plants). A non-exhaustive list of cover crops examples is given, from the USDA database, below in TABLE 1. (Source is USDA, Natural Resources Conservation Service, U.S. Department of Agriculture).

TABLE 1
Cover Crop Plants

| Symbol | Scientific Name | Common Name | Plant Family |
|---|---|---|---|
| AMCA3 | Amaranthus caudatus | foxtail amaranth | Amaranthaceae - |
| | | | Amaranth family |
| AMCR4 | Amaranthus cruentus | red amaranth | Amaranthaceae - |
| | | | Amaranth family |
| AMHY2 | Amaranthus hypochondriacus | Prince-of-Wales | Amaranthaceae - |
| | | feather | Amaranth family |
| AMHY4 | Amaranthus hybridus × | Plainsman amaranth | Amaranthaceae - |
| | hypochondriacus | | Amaranth family |
| ARGL18 | Arachis glabrata | rhizoma peanut | Fabaceae - Pea family |
| ARHY | Arachis hypogaea | peanut | Fabaceae - Pea family |
| AVSA | Avena sativa | common oat | Poaceae - Grass family |
| AVST2 | Avena strigosa | black oats | Poaceae - Grass family |
| BEVU2 | Beta vulgaris | common beet | Chenopodiaceae - |
| | | | Goosefoot family |
| BEVUC | Beta vulgaris ssp. cicla | chard | Chenopodiaceae - |
| | | | Goosefoot family |
| BRHO2 | Bromus hordeaceus | soft brome | Poaceae - Grass family |
| BRJU | Brassica juncea | brown mustard | Brassicaceae - Mustard |
| | | | family |
| BRNAN2 | Brassica napus var. napus | rape | Brassicaceae - Mustard |
| | | | family |
| BRNAP | Brassica napus var. pabularia | Siberian kale | Brassicaceae - Mustard |
| | | | family |
| BRNI | Brassica nigra | black mustard | Brassicaceae - Mustard |
| | | | family |
| BRRAR | Brassica rapa var. rapa | field mustard | Brassicaceae - Mustard |
| | | | family |
| BRCA2 | Brassica campestris | | Brassicaceae - Mustard |
| | | | family |
| CACA27 | Cajanus cajan | pigeonpea | Fabaceae - Pea family |
| CAEN4 | Canavalia ensiformis | jack bean | Fabaceae - Pea family |
| CASA2 | Camelina sativa | false flax | Brassicaceae - Mustard |
| | | | family |
| CATI | Carthamus tinctorius | safflower | Asteraceae - Aster family |
| CHQU | Chenopodium quinoa | quinoa | Chenopodiaceae - |
| | | | Goosefoot family |
| CIAR5 | Cicer arietinum | chick pea | Fabaceae - Pea family |
| CIIN | Cichorium intybus | chicory | Asteraceae - Aster family |
| CRJU | Crotalaria juncea | sunn hemp | Fabaceae - Pea family |
| CUCUR | Cucurbita | gourd | Cucurbitaceae - Cucumber |
| | | | family |
| CYTE11 | Cyamopsis tetragonoloba | guar | Fabaceae - Pea family |
| DACAS2 | Daucus carota var. sativus | carrot | Apiaceae - Carrot family |
| ECCR | Echinochloa crus-galli | barnyardgrass | Poaceae - Grass family |
| ELHO3 | Elymus hoffmannii | RS wheatgrass | Poaceae - Grass family |
| ELTR7 | Elymus trachycaulus | slender wheatgrass | Poaceae - Grass family |
| ERTE | Eragrostis tef | teff | Poaceae - Grass family |
| ERVES | Eruca vesicaria ssp. sativa | rocketsalad | Brassicaceae - Mustard |
| | | | family |
| FAES2 | Fagopyrum esculentum | buckwheat | Polygonaceae - |
| | | | Buckwheat family |
| GLMA4 | Glycine max | soybean | Fabaceae - Pea family |
| HEAN3 | Helianthus annuus | common sunflower | Asteraceae - Aster family |
| HOPU | Hordeum pusillum | little barley | Poaceae - Grass family |
| HORDE | Hordeum | barley | Poaceae - Grass family |
| HOVU | Hordeum vulgare | common barley | Poaceae - Grass family |
| INHI | Indigofera hirsuta | | Fabaceae - Pea family |
| LAPU6 | Lablab purpureus | hyacinthbean | Fabaceae - Pea family |
| LASA2 | Lathyrus sativus | white pea | Fabaceae - Pea family |
| LASY | Lathyrus sylvestris | flat pea | Fabaceae - Pea family |
| LECA8 | Lespedeza capitata | roundhead | Fabaceae - Pea family |
| | | lespedeza | |
| LECU2 | Lens culinaris | lentil | Fabaceae - Pea family |
| LIUS | Linum usitatissimum | common flax | Linaceae - Flax family |
| LOCO6 | Lotus corniculatus | bird's-foot trefoil | Fabaceae - Pea family |
| LOMU | Lolium multiflorum | | Poaceae - Grass family |
| LORI | Lolium rigidum | Wimmera ryegrass | Poaceae - Grass family |
| LOTE2 | Lolium temulentum | Darnel ryegrass | Poaceae - Grass family |
| LOTE4 | Lotus tenuis | narrowleaf trefoil | Fabaceae - Pea family |
| LUAL22 | Lupinus albus | white lupine | Fabaceae - Pea family |
| LUAN4 | Lupinus angustifolius | narrowleaf lupine | Fabaceae - Pea family |
| LUPIN | Lupinus | lupine | Fabaceae - Pea family |
| MEIN2 | Melilotus indicus | annual yellow | Fabaceae - Pea family |
| | | sweetclover | |
| MELI5 | Medicago littoralis | water medick | Fabaceae - Pea family |
| MELU | Medicago lupulina | black medick | Fabaceae - Pea family |
| MEOF | Melilotus officinalis | sweetclover | Fabaceae - Pea family |
| MEAL12 | Melilotus alba | | Fabaceae - Pea family |
| MEPO3 | Medicago polymorpha | burclover | Fabaceae - Pea family |
| MERU3 | Medicago rugosa | | Fabaceae - Pea family |
| MESA | Medicago sativa | alfalfa | Fabaceae - Pea family |
| MESC6 | Medicago scutellata | snail medick | Fabaceae - Pea family |
| METR10 | Medicago truncatula | barrelclover | Fabaceae - Pea family |
| MUPR | Mucuna pruriens | velvet bean | Fabaceae - Pea family |
| ONVI | Onobrychis viciifolia | sainfoin | Fabaceae - Pea family |
| PAMI2 | Panicum miliaceum | proso millet | Poaceae - Grass family |
| PEGL2 | Pennisetum glaucum | pearl millet | Poaceae - Grass family |
| PHTA | Phacelia tanacetifolia | lacy phacelia | Hydrophyllaceae - |
| | | | Waterleaf family |
| PISA6 | Pisum sativum | garden pea | Fabaceae - Pea family |
| POPR | Poa pratensis | Kentucky bluegrass | Poaceae - Grass family |
| PSJU3 | Psathyrostachys juncea | Russian wildrye | Poaceae - Grass family |
| PUDI | Puccinellia distans | weeping alkaligrass | Poaceae - Grass family |
| PUNU2 | Puccinellia nuttalliana | Nuttall's alkaligrass | Poaceae - Grass family |
| RASA2 | Raphanus sativus | cultivated radish | Brassicaceae - Mustard |
| | | | family |
| SEBI3 | Sesbania bispinosa | dunchi fiber | Fabaceae - Pea family |
| SEAC7 | Sesbania aculeata | | Fabaceae - Pea family |
| SECE | Secale cereale | cereal rye | Poaceae - Grass family |
| SEEX | Sesbania exaltata | | Fabaceae - Pea family |
| SEIT | Setaria italica | foxtail millet | Poaceae - Grass family |
| SESE8 | Sesbania sesban | Egyptian riverhemp | Fabaceae - Pea family |
| BRHI2 | Brassica hirta | | Brassicaceae - Mustard |
| | | | family |
| SOBI2 | Sorghum bicolor | sorghum | Poaceae - Grass family |
| SOBI5 | Sorghum bicolor var. bicolor × | Sudex | Poaceae - Grass family |
| | bicolor var. sudanense | | |
| SPOL | Spinacia oleracea | spinach | Chenopodiaceae - |
| | | | Goosefoot family |
| THIN6 | Thinopyrum intermedium | intermediate | Poaceae - Grass family |
| | | wheatgrass | |
| THPO7 | Thinopyrum ponticum | tall wheatgrass | Poaceae - Grass family |
| TRAE | Triticum aestivum | common wheat | Poaceae - Grass family |
| TRAL6 | Trifolium alexandrinum | Egyptian clover | Fabaceae - Pea family |
| TRAM15 | Trifolium ambiguum | Kura clover | Fabaceae - Pea family |
| TRFR2 | Trifolium fragiferum | strawberry clover | Fabaceae - Pea family |
| TRHI4 | Trifolium hirtum | rose clover | Fabaceae - Pea family |
| TRHY | Trifolium hybridum | alsike clover | Fabaceae - Pea family |
| TRIGO | Trigonella | fenugreek | Fabaceae - Pea family |
| TRIN3 | Trifolium incarnatum | crimson clover | Fabaceae - Pea family |
| TRITI2 | ×Triticosecale [Secale × Triticum] | triticale | Poaceae - Grass family |
| TRPR2 | Trifolium pratense | red clover | Fabaceae - Pea family |
| TRRE3 | Trifolium repens | white clover | Fabaceae - Pea family |
| TRRI | Triticosecale rimpaui [Secale cereale × | triticale | Poaceae - Grass family |
| | Triticum aestivum] | | |
| TRSU3 | Trifolium subterraneum | subterranean clover | Fabaceae - Pea family |
| TRVE | Trifolium vesiculosum | arrowleaf clover | Fabaceae - Pea family |
| BRRA80 | Brachiaria ramosa | | Poaceae - Grass family |
| VIBE | Vicia benghalensis | | Fabaceae - Pea family |
| VIAT2 | Vicia atropurpurea | | Fabaceae - Pea family |
| VIFA | Vicia faba | fava bean | Fabaceae - Pea family |
| VIGR | Vicia grandiflora | large yellow vetch | Fabaceae - Pea family |
| VIRA4 | Vigna radiata | mung bean | Fabaceae - Pea family |
| VISA | Vicia sativa | garden vetch | Fabaceae - Pea family |
| VIUN | Vigna unguiculata | cowpea | Fabaceae - Pea family |
| VIVI | Vicia villosa | winter vetch | Fabaceae - Pea family |
| FEME | Festuca megalura | | Poaceae - Grass family |
| ZEMA | Zea mays | corn | Poaceae - Grass family |

In some embodiments, the plant can be a herbaceous plant (i.e., lacking a persistent woody stem above ground). In some embodiments, the plants can be cultivated and harvested above-ground agricultural crops, such as maize, corn, sorghum, soybeans, beans, peas, rape, foraging grasses, legume grasses, and the like. In some embodiments, the plant can be a vegetable.

In some embodiments, the plant substrate can be cultivated and harvested above and

below ground whole-plant (i.e. root and leaf top, and in some embodiments, non-woody stem) root crops, such as turnips, beets, sugar beets, carrots, rutabagas, daikon radish, white radish, potato roots and potato vines, and the like.

In some embodiments, the substrate can be non-cultivated plants, such as grasses, weeds, tubers, broadleafs, perennials, annuals, and the like. Generally, the plant substrates used can have a moisture content higher than 50% at time of processing. Generally, there is no limit to moisture content for this method as, in some embodiments, the more moisture, the more successful the process for making fermented fertilizer by this method.

In some embodiments, the plant substrates for fermentation can be root vegetables. Root vegetables can refer to underground parts of plants that can be eaten as food by animals, including humans. Root vegetables can include true roots (e.g., taproots, tuberous roots) and non-roots (e.g., bulbs, corms, rhizomes, tubers). Root vegetables can have leaves and/or greens.

In some embodiments, the root vegetable can be a taproot. Taproots can include beetroot, burdock, carrot, dandelion, parsley, parsnip, radish (e.g., daikon radish), rutabaga, sugar beet, turnip, taro, chicory, and the like.

In some embodiments, the root vegetable can have edible greens. In some embodiments, these root vegetables can include arracacha, beets, carrots, celeriac, daikons, ginger, leeks, onions, radishes, rutabaga, turmeric, turnips, sweet potatoes, and the like.

In some embodiments, the root vegetables can be corms, including for example, Amorphophallus konjac (konjac), Colocasia esculenta (taro), Eleocharis dulcis (Chinese water chestnut), Ensete spp. (enset), Nymphaea spp. (waterlily), Pteridium esculentum, Sagittaria spp. (arrowhead or wapatoo), Typha spp., Xanthosoma spp. (malanga, cocoyam, tannia, yautia and other names), Colocasia antiquorum (eddoe or Japanese potato) and the like.

In some embodiments, the root vegetables can be bulbs, including Allium cepa (onion), Allium sativum (garlic), Camassia quamash (blue camas), Foeniculum vulgare (fennel) and the like.

In some embodiments, the root vegetables can be rhizomes, including Curcuma longa (turmeric), Panax ginseng (ginseng), Arthropodium spp. (rengarenga, vanilla lily, and others), Canna spp. (canna), Cordyline fruticosa (ti), Maranta arundinacea (arrowroot), Nelumbo nucifera (lotus root), Typha spp. (cattail or bulrush), Zingiber officinale (ginger, galangal), and the like.

In some embodiments, the root vegetables can be tuberous stems, including Apios americana (hog potato or groundnut), Cyperus esculentus (tigernut or chufa), Helianthus tuberosus (Jerusalem artichoke or sunchoke), Hemerocallis spp. (daylily), Lathyrus tuberosus (earthnut pea), Oxalis tuberosa (oca or New Zealand yam), Plectranthus edulis and P. esculentus (kembili, dazo, and others), Solanum tuberosum (potato), Stachys affinis (Chinese artichoke or crosne), Tropaeolum tuberosum (mashua or añu), Ullucus tuberosus (ulluku), and the like.

In some embodiments, the root vegetables can include Zamia integrifolia (Florida arrowroot), and the like.

In some embodiments, the root vegetables can be taproots, including Arracacia xanthorrhiza (arracacha), Beta vulgaris (beet and mangelwurzel), Brassica spp. (kohlrabi, rutabaga and turnip), Bunium persicum (black cumin), Burdock (Arctium, family Asteraceae), Carrot (Daucus carota subsp. sativus), Celeriac (Apium graveolens rapaceum), Daikon—the large East Asian white radish (Raphanus sativus var. longipinnatus), Dandelion (Taraxacum) spp., Lepidium meyenii (maca), Microseris lanceolata (murnong or yam daisy), Pachyrhizus spp. (jicama and ahipa), Parsnip (Pastinaca sativa), Petroselinum spp. (parsley root), Radish (Raphanus sativus), Scorzonera hispanica (black salsify), Sium sisarum (skirret), Tragopogon spp. (salsify), Vigna lanceolata (bush carrot or bush potato) and the like.

In some embodiments, the root vegetables can be tuberous roots, including Amorphophallus galbra (yellow lily yam), Conopodium majus (pignut or earthnut), Dioscorea spp. (yams, ube), Dioscorea polystachya (nagaimo, Chinese yam, Korean yam, mountain yam, white ñame), Hornstedtia scottiana (native ginger), Ipomoea batatas (sweet potato), Ipomoea costata (desert yam), Manihot esculenta (cassava or yuca or manioc), Mirabilis expansa (mauka or chago), Psoralea esculenta (breadroot, tipsin, or prairie turnip), Smallanthus sonchifolius (yacón) and the like.

In some embodiments, the fermentation will include fermenting both the root and the leaf, together and simultaneously.

Generally, the plants can be of any variety. In some embodiments, the plants can be turnips. In some embodiments, a turnip can be Brassica rapa turnips (purple top turnips).

In some embodiments, the plants can be grown without fertilization. In some embodiments, the soil can have a pH below 7. In some embodiments, the soil can have a pH of or below 7.0, 6.9, 6.8, 6.7, 6.6, 6.5, 6.4. 6.3, 6.2, 6.1, 6.0, 5.9, 5.8, 5.7, 5.6, 5.5, 5.4, 5.3, 5.2, 5.1, 5.0, 4.9, 4.8, 4.7, 4.6, 4.5, 4.4, 4.3, 4.2, 4.1, 4.0, 3.9 or 3.8. In some embodiments, the soil can have organic matter of or above 1, 2, 3, 4, 5, 6, 7, 8, 9, 10, 11, 12, 13, 14, 15, 16, 17, 18, 19, 20, 21, 22, 23, 24, 25 or more percent. In some embodiments, the soil can have a base saturation percent of calcium at or about 30, 31, 32, 33, 34, 35, 36, 37k 38, 39, 40, 41, 42, 43, 44, 45 percent. In some examples, the soil can have a base saturation percent of magnesium of or about 3, 4, 5, 6, 7, 8, 9 or 10 percent. In some embodiments, the soil can have any one or more of the characteristics shown in TABLE 2, in Example 1.

In some embodiments, the plants can be grown for about 90 days. In some embodiments, the plants can be grown in the northern United States, including Alaska.

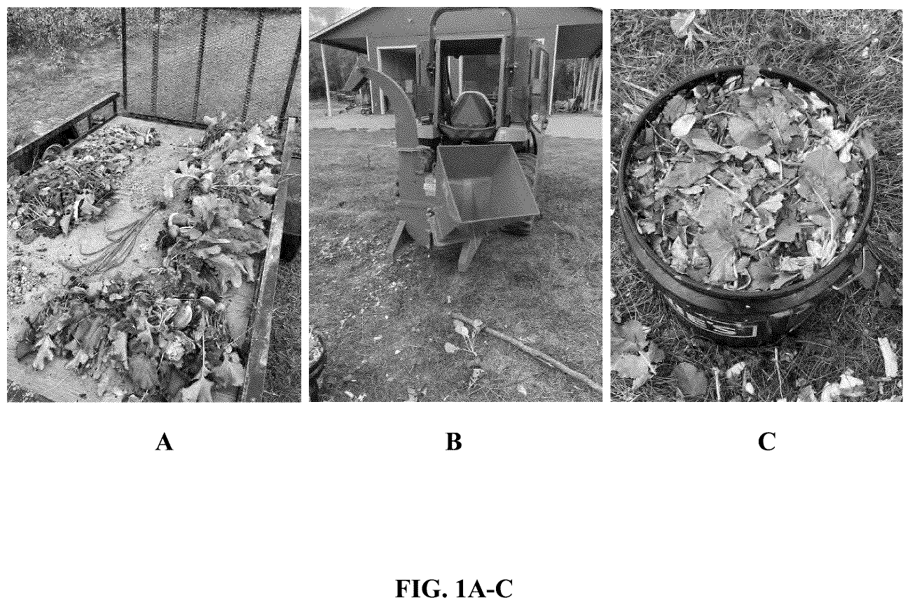

In some embodiments, the plants can be harvested without washing or cleaning (FIG. 1A shows turnips). In some embodiments, the plants can be shaken to remove some or all of the soil on the plants. In some embodiments, the plants can be shredded/chopped/chipped prior to fermentation (FIG. 1C shows chipped turnips). In some embodiments, a chipper can be used to shred/chop/chip the plants (FIG. 1B). In some embodiments, the shredded/chopped/chipped plants can be “reasonably” packed into a confined, enclosed space or vessel (e.g., compacted) prior to the fermentation (FIG. 1C shows turnips). Generally, the fermentation container will capture and retain effluents (fluids) created during the fermentation process.

### Fermentation by Homfermentative and Heterofermentative Lactic Acid Bacteria

Herein, fermentation refers to an anaerobic process, performed by microorganisms (e.g., bacteria). In some embodiments, the process can include breakdown of carbohydrates (e.g., glucose). In some embodiments, energy (e.g., ATP) can be produced. Herein, the source of substrate for the fermentations can be plants, as discussed above.

In some embodiments, fermentation can be heterofermentative. Herein, heterofermentation can describe a process whereby a microorganism ferments glucose and produces CO₂. In some embodiments, 1 mole of glucose is catabolized to 1 mole of lactic acid, 1 mole of ethanol and 1 mole of CO₂, generating 1 mole of ATP.

In some embodiments, fermentation can be homofermentative. Herein, homofermentation can describe a process whereby a microorganism ferments glucose and does not produce CO₂. In some embodiments, 1 mole of glucose is catabolized to 2 moles of lactic. No CO₂ is produced. Two moles of ATP are generated.

In this disclosure, at least a part of the fermentation can be performed by homofermentative microorganisms. In some embodiments, a majority of the fermentation can be performed by homofermentative microorganisms. In some embodiments, the fermentation can be exclusively performed by homofermentative microorganisms. The homofermetative microorganisms can be bacteria. In some embodiments, the homofermentative bacteria can be lactic acid bacteria. In some embodiments, the fermentations can be carbon-neutral or largely carbon neutral. In some embodiments, if the time period when the plant substrates for the fermentation is considered, the process beginning when the plant begins conducting photosynthesis and ending when a fermentation is completed, the process can be carbon negative (carbon captured in the plant by photosynthesis is retained in the fermentate).

In some embodiments, the fermentations described herein can have homofermentative bacteria that are at least 10, 20, 30, 40, 50, 60, 70, 80, 90 or 99% of bacteria in the fermentate. In some embodiments, the fermentations described herein can have a ratio of homofermentative lactic acid bacteria to bacteria capable of producing CO₂ in the fermentate of at least about 1:1, 2:1, 3:1, 4:1, 5:1, 6:1, 7:1, 8:1 or 9:1. In some embodiments, at least some of the heterofermentative bacteria in the fermentation can be lactic acid bacteria (LAB).

Lactic acid bacteria acid can be part of the phylum Firmicutes, class Bacilli, and order Lactobacillales. The order Lactobacillales can include six families, i.e., Aerococcaceae, Carnobacteriaceae, Enterococcaceae, Lactobacillaceae, Leuconostocaceae, and Streptococcaceae, over 30 genera, and more than 300 species. Lactic acid bacteria can be divided into two subgroups: heterofermentative lactic acid bacteria and homofermentative LAB.

Heterofermentative lactic acid bacteria can be readily distinguished from homofermentative bacteria in the laboratory using a hot-loop test. In liquid growth medium, CO₂ produced by heterofermentative lactic acid bacteria generally stays in solution. When temperature of the solution is increased, CO₂ becomes insoluble and is released as a gas. In the hot-loop test, lactic acid bacteria are grown to saturation in a medium containing glucose. A wire inoculating loop is heated (red hot) and plunged into the medium. When heterofermentative lactic acid bacteria are in the culture, CO₂ bubbles will be seen around the loop (instr.bact.wisc.edu/book/displayarticle/95 #:˜:text=Lactic%20acid%20bacteria %20can%20be,major%20product%20of%20this%20fermentation.).

In some embodiments, homofermentative lactic acid bacteria can be from genera Lactococcus, Enterococcus, Streptococcus, Pediococcus or group I lactobacilli. In some embodiments, the homofermentative bacteria can be Latilactobacillus sakei (formerly genus Lactococcus).

In some embodiments, the bacteria can include Lactobacillus lactis.

Herein, plants that are undergoing fermentation, in combination with the microbes facilitating the fermentation, can be referred to as a fermentate. Plants that have completed fermentation (e.g., fermentate that is ready for use as fertilizer) can also be referred to as a fermentate. In some examples, fermentate that is ready for use as fertilizer, contact herbicide, and a soil P-K booster/amendment, can be referred to as a final fermentate. Fermentates can contain materials that are solid (e.g., plants). Fermentates can also include liquid material, which can be called an effluent. In some embodiments, a fermentate herein that can be used as a fertilizer, includes both the solid material and the liquid, effluent material. In some embodiments, the fermentate liquid includes lactic acid, which can be used as a soil amendment/soil P-K booster. In some embodiments, the fermentate liquid includes acetic acid, which can be used as a contact broadleaf herbicide.

Herein, fermentation can occur under anaerobic or partially anaerobic conditions. In some embodiments, example conditions in which fermentation can occur can be conditions under which obligate anaerobic bacteria can divide and/or ferment carbohydrates. In some embodiments, example conditions in which fermentation can occur can be conditions under which obligate anaerobic and facultative anaerobic bacteria can divide and/or ferment carbohydrates. In some embodiments, example conditions in which fermentation can occur can include up to 2-8% oxygen in the environment.

Plant fermentation, as described herein, can be open fermentation. Open fermentations are open to the environment. For example, making silage (ensiling) can be an open fermentation process. Plants can be piled in a field and remain there for days, weeks or months. Under these conditions, plants on the exterior of the pile are exposed to oxygen (aerobic conditions). Plants on the interior of the pile can be exposed to anaerobic conditions under which fermentation can occur. Open fermentation can occur in vessels, for example, in which the vessel top is removed.

Plant fermentation, as described herein, can be closed fermentation. Closed fermentation can occur in closed, airtight or hermetically-sealed container (or vessel). Examples of these container can be closed tanks or fermenters. In some embodiments, a closed container can be a plastic container (e.g., FIG. 1C) onto which an airtight lid can be positioned. In some embodiments, an airtight container that has a valve can be used. In some embodiments, the valve can provide for continuous off-gassing. Other containers can be used. In some embodiments of a closed fermentation, an airtight container can be vented (e.g., during a gas build-up around or soon after—during the first week—the fermentation has been initiated) and then resealed.

In some embodiments, fermentation is performed in a bunker, pit or silo.

In some embodiments, however the fermentation is performed, effluent from the fermentation is collected. In some embodiments, the effluent is part of the fermentate, as described herein. Fermentation to retain the effluent can use containers, bunkers, pits, silos, and the like, that are designed or designed with systems to retain the effluent.

Herein, plant material that will undergo fermentation can be exposed to or can be placed under conditions in which fermentation can occur. Conditions under which fermentation can occur can include, for example, a permissive temperature or humidity. In some embodiments, a temperature range for fermentation can be between about 32°-120° Fahrenheit (° F.). In some embodiments, a temperature range for fermentation can be greater than about 32° F. and lesser than about 80, 75, 70, 65, 60, 55, 50, 45 or 40° F. In some embodiments, the ambient air temperature during fermentation can be between about 32°-60° F.

In some embodiments, the temperature range for fermentation can be the temperature range found in southern Alaska (e.g., Anchorage) during the months of May, June, July, August, September, and October. Conditions under which fermentation can occur can also include presence of a fermentable carbon source, presence of nutrients that provide for the bacteria to grow, water and the like.

Fermentation can take time. In some embodiments, the plant fermentations disclosed herein can least at least 10, 20, 30, 45, 60, 75, 90, 105, 120 or 135 days. In some examples, at the end of this time, the fermentation by the microorganisms to which the plants are exposed can have ceased. In some embodiments, the fermentation can cease because the amount of fermentable material in the fermentation can be low or exhausted, pH of the fermentate may be too low for microorganisms to continue fermenting, and other factors may affect when fermentation ends.

Fermentation requires microorganisms. In some embodiments, plants and/or surfaces of plants naturally contain microorganisms that are capable of fermentation. For example, the bacteria can be naturally available on the plant substrate, in the attached soil or in water naturally adhering to the plant. When the plant materials are exposed to an anaerobic environment under conditions in which fermentation can occur, some of the bacteria associated with the plant can initiate fermentation. This can be the situation when cabbage is fermented to make sauerkraut, for example. In embodiments, the plants used in the methods and products disclosed herein, have associated microorganisms (e.g., bacteria) that can ferment the plant material. In some embodiments, the associated microorganisms can include bacteria. In some embodiments, the associated microorganisms can include lactic acid bacteria. In some embodiments, the lactic acid bacteria can be homofermentative bacteria. In some embodiments, the bacteria can be heterofermentative and homofermentative bacteria.

Herein, use of homofermentative lactic acid bacteria in the fermentation is favored to reduce the amount of CO₂ released into the atmosphere and create the maximum amount of lactic acid for soil amendment purposes. Herein, use of homofermentative lactic acid bacteria in the fermentation is favored to increase the amount of lactic acid by percentage versus other volatile fatty acids, in order to increase the efficacy of solubilizing P-K organic compounds resident in soil. Herein, the disclosed fermentations produce a fermentate that is used as fertilizer. Herein, the disclosed fermentations produce a fermentate this is used to make soil P-K organic compounds soluble, and plant-available. In the art, fermentations (ensiling) used to produce animal feed (silage) are not concerned with decreasing or eliminating carbon dioxide. In the art, fermentation methods (ensiling) used to produce animal feed (silage) are designed to avoid the production of effluent. In the art, fermentation methods (ensiling) used to produce animal feed do not capture inadvertent, excess effluents; effluents are allowed to leach through the ground. In the art, whole-plant (root and leaf) root crop plants, freshly harvested from the field, are not fermented together, or used to produce animal feed (silage). In the art, broadleaf weeds, freshly harvested from the field, are not fermented, and not used to produce animal feed.

In some embodiments, an inoculant and/or starter culture of microorganisms (e.g., lactic acid bacteria) can be added to the plant materials at or around the time plant material is exposed to anaerobic conditions. In some embodiments, the inoculant and/or starter cultures can be added to the plant materials after the fermentation has begun. In some embodiments, the inoculant and starter cultures can contain homofermentative lactic acid bacteria. In some embodiments, the inoculants can be bacteria that can produce soluble phosphate and/or potassium from insoluble sources. In some embodiments, dissolved sugar(s) inoculants (e.g. sucrose) can be added to the plant materials at or around the time the plant material is exposed to anaerobic conditions.

In some embodiments, the conditions under which fermentation can occur can be conditions that favor or even select for growth of bacteria that are homofermentative. In some embodiments, these bacteria can be lactic acid bacteria. In some embodiments, the conditions under which fermentation can occur can be conditions that disfavor or even select against growth of bacteria that produce CO₂. In some embodiments, these bacteria can be heterofermentative. In some embodiments, these bacteria can be heterofermentative lactic acid bacteria.

Media that are selective for lactic acid bacteria exist (Reuter, G. “Elective and selective media for lactic acid bacteria.” International Journal of Food Microbiology 2.1-2 (1985): 55-68.). Media that are selective for certain types of lactic acid bacteria also exist (Bergsveinson, Jordyn, et al. “Dissolved carbon dioxide selects for lactic acid bacteria able to grow in and spoil packaged beer.” Journal of the American Society of Brewing Chemists 73.4 (2015): 331-338.). Media that differentiate between homofermentative and heterofermentative lactic acid bacteria also exist (McDonald, L. C., et al. “A differential medium for the enumeration of homofermentative and heterofermentative lactic acid bacteria.” Applied and environmental microbiology 53.6 (1987): 1382-1384.). Substances or compositions that favor and/or select for homofermentative lactic acid bacteria can be added to the fermentations disclosed herein. Substances or compositions that disfavor and/or select against heterofermentative lactic acid bacteria can be added to the fermentations disclosed herein.

Herein, CO₂ scavengers can be substances that can sequester or remove CO₂ from a fermentation. In some embodiments, substances that can scavenge CO₂ can be added to the plant substrate material at or during fermentation. In some embodiments, CO₂ scavengers can be connected in-line to the fermentation. CO₂ scavengers are known in the art (tetratec.com/oil-and-gas-services/completion-fluids-additives/corrosion-control/scavengers/; foremarkperformance.com/puremark-scavengers-brand/; Lee, Dong Sun. “Carbon dioxide absorbers for food packaging applications.” Trends in Food Science & Technology 57 (2016): 146-155.). While use of CO₂ scavengers may not facilitate growth of homofermentative lactic acid bacteria, in some embodiments, the goal of making a fermentation that produces low or no CO₂ can be obtained using these scavengers.

In some embodiments, microorganisms that can utilize CO₂ can be added to the fermentation. In some embodiments, microorganisms that utilize and convert CO₂ to biomass can be added to the fermentation. Bacteria that utilize CO₂ and convert it to biomass are known (Onyeaka, Helen, and O. C. Ekwebelem. “A review of recent advances in engineering bacteria for enhanced CO2 capture and utilization.” International Journal of Environmental Science and Technology 20.4 (2023): 4635-4648.). Use of these bacteria can facilitate obtaining a goal of a fermentation that produces low or no CO₂.

The conditions under which the plants are placed can be anaerobic or nearly anaerobic. In some embodiments, the plants can be placed into a confined space that can be enclosed with an airtight lid, door, or covering, in order to prevent the entrance of oxygen into the “pile”. In some embodiments, the plants can be placed into a container or structure where any exposed faces can and are covered by nonpermeable plastic, canvas, tarps, or materials such as soil layers or sand, in order to prevent the entrance of oxygen into the “pile”. In some embodiments, containers like a bucket can be used. These containers can be covered with a lid which generally can be airtight. The lid can be used to seal the container.

In some embodiments, the fermentation structures or fermentation vessels can trap and contain fluids that accumulate during fermentation and not allow the accumulated fluids (effluents) to leach into the soil or escape containment. In some embodiments, the fluids remain accumulated, and not separated, from the solid fermenting plant substrates, as these fermented plant substrates represent a useful and desired source of organic carbon for soil maintenance and enhancement by a fertilizer; as well as lactic acid which represents a useful and desired source to solubilize organic P-K compounds resident in the soil for enhancement by a fertilizer; as well as acetic acid which represents a useful and desired source to kill broadleaf plants simultaneously when the fertilizer, organic carbon, and lactic acid are being added to the soil, prior to planting. In addition, these fermented plant substrates are moist and concentrated with soluble, plant-available N-P-K. In another embodiment, the raw material plant substrates are processed without washing or cleaning.

In some embodiments, sugars in the form of molasses or other sucrose, fructose, or glucose-rich substances or concentrates can be added to the plant substrate. This can provide a readily available (initial) source of food for the fermentation. In some embodiments, these additives can selectively promote growth of homofermentative lactic acid bacteria.

### Phosphate- and Potassium-Solubilizing Bacteria

Phosphorus solubilizing bacteria (PSB) and potassium solubilizing bacteria (KSB) exist naturally in soil and water, and convert organic phosphorus and potassium into inorganic, plant-available phosphorus and potassium. These organisms-are normally used as a soil inoculant to produce plant-usable forms of phosphorus and potassium from organic sources resident within the soil.

Disclosed is using these microorganisms in fermentations to increase levels of plant-usable phosphorus and potassium in fermentates used as fertilizers.

In some embodiments, the bacterium, Rhanella aquatilis, can convert insoluble phosphate to a soluble form.

In some embodiments, the bacterium Serratia plymuthica, can convert insoluble phosphate to a soluble form.

### Fermented Plants as Fertilizers

The fermentates produced by the fermentations described herein are used as fertilizers. In some embodiments, the fertilizers can have protein, fixed nitrogen, soluble phosphorus and/or potassium. In some embodiments, the fertilizers can have a crude protein content of at least 10% dry mass. In some embodiments, the fertilizers can have a fixed nitrogen content (e.g., ammonia). In some embodiments, the fertilizers can have a soluble phosphate content of at least 8.0 lbs/1000 gallon.

In the art, a primary and exclusive purpose for fermenting (ensiling) agricultural crops is to produce a preserved feed source for livestock consumption (silage). Currently, ensiling agricultural crops is not done for the end purpose to produce a fertilizer. In some embodiments, herein, fermentations to produce fertilizer retain the effluent. Fermentation for animal feed generally does not retain effluent. Silage high in effluent is generally the result of a mistake, whereby the processor fails to follow the standard usual and normal operation(s) of making feed silage. In fact, effluent pollution of rivers and streams was an “offence in law in Scotland since 1951”, thus demonstrating how undesirable effluents can be and the measures to prevent their creation, serious (THE POTENTIAL VALUE OF SILAGE EFFLUENT AS A FERTILIZER, D. PURVES AND P. MCDONALD, School of Agriculture, Edinburgh, September 1963). In the art, whole plant (leaf and root) root crops or the leaf and non-woody stem of root crops are not used for silage (animal feed), as they are high in moisture and require cleaning, as necessitated by the art, to avoid pathogen contamination. As an example of proof, mechanical harvesters of root crops are designed to separate root from leaf, where the root is the product objective and the leaf is regarded as a waste. In the art, broadleaf weeds are not used for silage (animal feed). Broadleaf weeds are destroyed via herbicides or by mechanical action or both. Broadleaf weeds negatively impact business operations and overall profitability.

The normal and usual operational processes to ensile agricultural crops to make animal feed are well established within the agricultural industry. A successful fermentation, exclusively for feed purposes, is achieved by complying with the following guidelines: (1) select plants livestock will normally eat (i.e., they are not plants, such as weeds or other plant substrates avoided by livestock in their normal environment); (2) ensile those plants between a minimum moisture content of 50% and maximum moisture content below 70%, wilting the plants if necessary, to avoid effluent production; (3) avoid ensiling at lower temperatures, as these may result in a “restricted fermentation”, whereby low pH is not achieved; (4) avoid soil contamination of the plant substrate, to help prevent the growth of unwanted pathogens; (5) drain, divert, and/or prevent the creation and accumulation of effluents within the silage, and (6) ensure the silage pile contains both heterofermentative and homofermentative bacteria and, if not resident, inoculate those plants with both heterofermentative and homofermentative strains of lactic acid bacteria, as acids made from heterofermentative processes break down more easily into acetic acid, a useful mold inhibitor for preserving the silage and (7) the normal and usual operation does not include fermenting whole root crops (leaf and root), nor the fermentation of root crop leaves, for silage feed.

These guidelines either are unnecessary or detrimental to fermenting to produce fertilizer as described herein. For example, fermentation to make fertilizer is (1) not concerned with palatability to animals (any plant can be used for fertilizer), (2) is not restricted to a maximum moisture content, (3) fermenting at lower temperatures is not generally an issue, (4) prevention of soil contamination is less important and instead is encouraged, (5) effluent creation is encouraged and effluent capture and retention is necessary, and (6) there is a focus on presence of homofermentative lactic acid bacteria, when concentrating on maximum carbon capture (heterofermentative can be used if acetic acid is desired, in order to produce a fertilizer with contact organic herbicide).

A focus on homofermentative improves the overall carbon-negative aspect of the process, and also allows more lactic acid to be produced. Excess lactic acid provides a soil amendment component for solubilizing organic phosphorus and potassium in the soil, thereby increasing the overall effectiveness of the product.

The previous guidelines are all followed unless the producer wishes to have an herbicidal capability, in which case inoculation of both homofermentative and heterofermentative is advised (for acetic acid production)

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

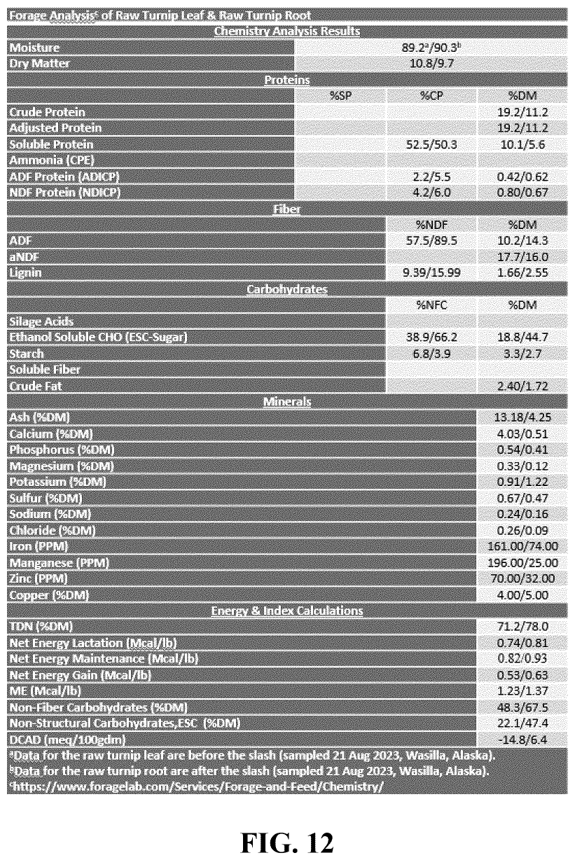

As stated and demonstrated in this application, any raw, fresh, unprocessed “plant” or part of a plant (i.e. non-woody stem, leaf, or root, or all three in combination) can be used as a raw-material feedstock source for this method of fermentate fertilizer. We selected purple top turnip (Brassica rapa) as our feed stock for fermentate fertilizer for several reasons: (1) it is a very fast growing plant, (2) this plant has excellent macronutrient scavenging abilities, resulting in high crude protein (nitrogen fertilizer source), phosphorus, and potassium uptake and retention, (3) required zero inputs (fertilizer, herbicides, irrigation), due to our soils and the fact we were not growing the plant as a human or animal food source, where weeds decrease yield-per-acre and overall food quality, (4) is extremely well-adapted to grow in our climate and temperature conditions, (5) has both high crude protein (for buffering) and high simple sugar content (for lactic acid fermentation), both of which combine to produce larg(er) amounts of lactic acid than a normal feed-stock (e.g. corn, alfalfa, etc.) for animal feed silage, and (6) has high moisture content, to assist in producing more lactic acid and more nutrient-rich effluent. See FIG. 12 for nutrient analysis of raw turnip leaf and raw turnip root, unfertilized.

In some embodiments, potential fermentate fertilizer producers can apply a similar plant-selection methodology, prior to following the fermentate methods described in this application and in the subsequent Examples.

### Example 1—Turnips and Soil

Brassica rapa turnips (purple top turnips) were grown in Wasilla, Alaska. Turnips for Bucket 1 and 2 (see Example 2) were planted, without prior or subsequent fertilization, in 2 separate fields in early June 2022 and harvested and used for fermentation on 10 Sep. 2022. Turnips for Bucket #3 were combined with a few turnips planted in early June 2022 from field locations as well as with a batch planted between 1-4 July from a section of fertilized garden; all of which were harvested and used for fermentation on 2 Oct. 2022.

In May 2022, soil tests were performed in 8 different fields on the property (Wasilla, Alaska) used primarily for farming commercial hay. These included the fields and field adjacent to the fields in which the turnips described above were grown. The soil tests were performed by Brookside Laboratories (New Bremen, Ohio). The data are shown in TABLE 2.

TABLE 2
Soil Report

| Sample | 1 | 2 | 3 | 4 | 5 | 6 | 7 | 8 |
|---|---|---|---|---|---|---|---|---|
| Total exchange | 11.45 | 12.04 | 4.95 | 8.23 | 10.86 | 4.07 | 7.41 | 14.83 |
| capacity (ME/100 g) | | | | | | | | |
| pH in buffer^{a} | 6.2 | 6.5 | 6.5 | 6.3 | 6.5 | 6.2 | 6.5 | 6.6 |
| pH in H₂O^{b} | 4.8 | 4.6 | 4.8 | 5.0 | 5.1 | 4.9 | 5.0 | 5.6 |
| Organic matter^{c} (%) | 11.98 | 13.02 | 11.21 | 15.43 | 13.72 | 16.29 | 15.38 | 20.75 |
| Estimated nitrogen | 126 | 127 | 126 | 128 | 127 | 128 | 128 | >130 |
| release (lb/A) | | | | | | | | |
| Soluble sulfur⁶ (ppm) | 46 | 42 | 31 | 28 | 34 | 21 | 25 | 21 |
| Phosphorus^{4, 6} (lb/A) | 229 | 151 | 179 | 256 | 220 | 298 | 554 | 256 |
| Phosphorus^{5, 6} (ppm) | 50 | 33 | 39 | 56 | 48 | 65 | 121 | 56 |
| Calcium⁶ (lb/A) | 1682 | 1590 | 7.8 | 1428 | 1948 | 620 | 1174 | 3348 |
| Calcium⁶ (ppm) | 841 | 795 | 354 | 714 | 974 | 310 | 587 | 1674 |
| Magnesium⁶ (lb/A) | 126 | 132 | 66 | 58 | 114 | 44 | 84 | 310 |
| Magnesium⁶ (lb/A) | 63 | 66 | 33 | 29 | 57 | 22 | 42 | 155 |
| Potassium⁶ (lb/A) | 122 | 74 | 36 | 32 | 76 | 46 | 122 | 128 |
| Potassium⁶ (ppm) | 61 | 37 | 18 | 16 | 38 | 23 | 61 | 64 |
| Sodium⁶ (lb/A) | 28 | 24 | 22 | 30 | 34 | 26 | 40 | 38 |
| Sodium⁶ (ppm) | 14 | 12 | 11 | 15 | 17 | 13 | 20 | 19 |

Base Saturation Percent

| | | | | | | | | |
|---|---|---|---|---|---|---|---|---|
| Calcium (%) | 36.72 | 33.01 | 35.76 | 43.38 | 44.84 | 38.08 | 39.61 | 56.44 |
| Magnesium (%) | 4.59 | 4.57 | 5.56 | 2.94 | 4.37 | 4.50 | 4.72 | 8.71 |
| Potassium (%) | 1.37 | 0.79 | 0.93 | 0.50 | 0.90 | 1.45 | 2.11 | 1.11 |
| Sodium (%) | 0.53 | 0.43 | 0.97 | 0.79 | 0.68 | 1.39 | 1.17 | 0.56 |
| Other bases (%) | 7.80 | 8.20 | 7.80 | 7.40 | 7.20 | 7.60 | 7.40 | 6.20 |
| Hydrogen (%) | 49.00 | 53.00 | 49.00 | 45.00 | 42.00 | 47.00 | 45.00 | 27.00 |

Extractable minors

| | | | | | | | | |
|---|---|---|---|---|---|---|---|---|
| Boron⁶ (ppm) | 0.20 | <0.20 | <0.20 | 0.21 | 0.27 | 0.21 | 0.22 | 0.26 |
| Iron⁶ (ppm) | 397 | 345 | 277 | 419 | 381 | 489 | 370 | 382 |
| Manganese⁶ (ppm) | 14 | 13 | 12 | 6 | 10 | 7 | 24 | 10 |
| Copper⁶ (ppm) | 1.26 | 1.26 | 1.01 | 1.09 | 1.22 | 1.11 | 0.99 | 1.53 |
| Zinc⁶ (ppm) | 1.28 | 2.54 | 2.45 | 2.77 | 2.89 | 3.38 | 4.69 | 1.97 |
| Aluminum⁶ (ppm) | 1477 | 1623 | 1654 | 1728 | 1737 | 1558 | 1586 | 1262 |
| NO₃—N (ppm) | 2.3 | 4.3 | 4.8 | 0.7 | 1.3 | 1.1 | 7.8 | 25.7 |
| NH₄—N (ppm) | <0.5 | 1.6 | 1.8 | 1.0 | 0.8 | 2.7 | 3.4 | 1.1 |

¹SMP/Sikora
²1:1
³360° C. LOI
⁴P as P₂O₅
⁵ppm of P
⁶Mehlich III extractable

The data indicate that the soil used for growing the turnips used for the methods and compositions disclosed herein had a relatively low pH, relatively high amount of organic matter, and relatively high amounts of calcium and magnesium.

### Example 2—Fermenting Root Vegetables—Turnips

Full turnips (both roots and greens), grown as in Example 1, were harvested. During harvesting, soil was lightly knocked-off of the turnips. The turnips were not washed. The harvested turnips are shown in FIG. 1A.

The harvested turnips—both roots and greens—were shredded using a power take-off wood-chipper (FIG. 1B). The shredded turnips were placed into an HDPE 2 (FDA designates as “Food Grade”) 5-gallon bucket (FIG. 1C). Shredded turnips were compressed by hand into the bucket. After filling to overflowing, the bucket was sealed with an impermeable plastic lid to create an airtight seal to initiate fermentation. Temperature at initiation of fermentation was between 50-60° F. Nothing was added to the turnips (e.g., additives, inoculants, liquids). Within the first week after fermentation initiation, a slight buildup of gas inside the buckets was evident. The gas buildup was released by slightly opening the edge of the lid and “burping” the gas. After gas release, the lids were immediately closed. The lids remained closed for the duration of the fermentation and opened only at the conclusion of the fermentation, when the fermentate was removed from the buckets. Temperatures during the fermentation were determined using an industrial laser temperature gun, focusing the gun on the external lid top of the buckets. Of note, there were never any temperature spikes, as is usually observed when animal silage processes and methods are used.

Two turnip fermentations were performed using the methods described above. The first fermentations (Bucket #1 and #2) were sealed on Sep. 10, 2022. The second fermentation (Bucket 3) was sealed on Oct. 2, 2022. The sealed buckets were placed in a root cellar. Temperature in the cellar during the 3-month fermentation period for Buckets #1-3 did not fall below 33° F. Maximum ambient temperature in the root cellar was approximately 59° F. for Buckets #1-2 and approximately 62° F. for Bucket #3 (TABLE 3). Gas buildup did not appear significant after the initial gas release during the first week of the fermentation, as discussed above. The sealed buckets were then not opened until completion of the fermentation process, as described below in TABLE 3.

TABLE 3
Environmental Temperature During
Fermentation^{a} (degrees Fahrenheit)

| Date | Bucket #1 | Bucket #2 | Bucket #3 | Notes |
|---|---|---|---|---|
| 10-Sep | 49 | 50 | | Buckets #1 & #2 initiated |
| 11-Sep | 49.5 | 51.7 | | |
| 12-Sep | 49.8 | 50.2 | | |
| 13-Sep | 46.5 | 52.3 | | |
| 14-Sep | 48.6 | 48.4 | | |
| 15-Sep | 47.4 | 51.9 | | Gas building in the buckets |
| 16-Sep | | | | Let gas out of both buckets |
| 17-Sep | 47.2 | 50.2 | | |
| 18-Sep | 47.8 | 48.2 | | |
| 19-Sep | 46.4 | 46.9 | | Gas building in the buckets |
| 22-Sep | 44.3 | 42.3 | | |
| 24-Sep | 46.1 | 48.9 | | |
| 26-Sep | 43.3 | 48.1 | | |
| 27-Sep | 45 | 46.5 | | |
| 28-Sep | 42.9 | 47.5 | | |
| 29-Sep | 45.8 | 47.5 | | |
| 1-Oct | 46.8 | 47.2 | | |
| 2-Oct | 46.8 | 48.8 | | Bucket #3 initiated |
| 3-Oct | 46.5 | 43.1 | | |
| 4-Oct | 45.3 | 47.2 | | |
| 5-Oct | | | 60.7 | |
| 6-Oct | 44.4 | 59.4 | 55.8 | |
| 7-Oct | 47.8 | 51.1 | 60 | |
| 9-Oct | 48.5 | 44 | 60.1 | |
| 10-Oct | 45.6 | 37.1 | 59.1 | |
| 12-Oct | 44 | 44.1 | | |
| 13-Oct | 42.4 | 43.3 | 58.3 | |
| 14-Oct | 39.9 | 40.9 | 58.3 | |
| 16-Oct | 41.3 | 42 | 62.4 | |
| 18-Oct | 43.3 | 42.7 | | |
| 22-Oct | 38.3 | 38.8 | 37.6 | |
| 24-Oct | 42.8 | 43.3 | 42.8 | |
| 26-Oct | 40.8 | 41.3 | 40.8 | |
| 28-Oct | 38.1 | 38.9 | 38.9 | |
| 30-Oct | 36.8 | 39.8 | 39.4 | |
| 1-Nov | 33.7 | 33.9 | 39.8 | |
| 7-Nov | 36 | 38.3 | 37.9 | |
| 10-Nov | 38.9 | 39.2 | 39.2 | |
| 15-Nov | 39.8 | 40.3 | 40.3 | |
| 22-Nov | 35.3 | 36.1 | 37.7 | |
| 24-Nov | 33.2 | 33.4 | 32.2 | |
| 28-Nov | 34.3 | 35.3 | 33 | |
| 10-Dec | | | 35 | |
| 13-Dec | | | | Buckets #1 & #2 opened |
| 16-Jan | | | | Bucket #3 opened |

^{a}Temperatures were taken outside of the buckets, near the bucket lid

### Example 3—Fertilizer from Turnips

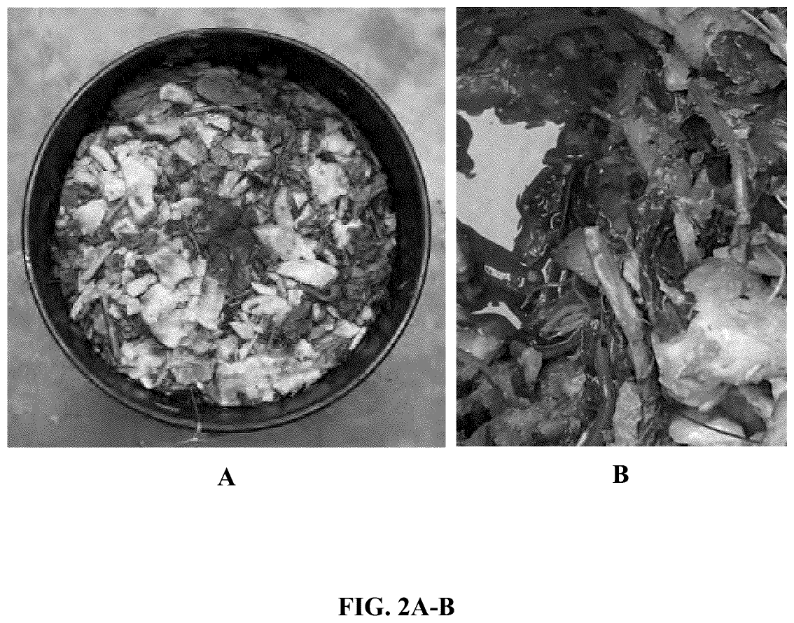

Fermented Bucket #1 was opened on Dec. 13, 2022. Upon opening, the fermentations had an appearance as shown in FIG. 2A-B. Upon unsealing, pH of the fermentate was 4.4 as measured with a handheld pH meter.

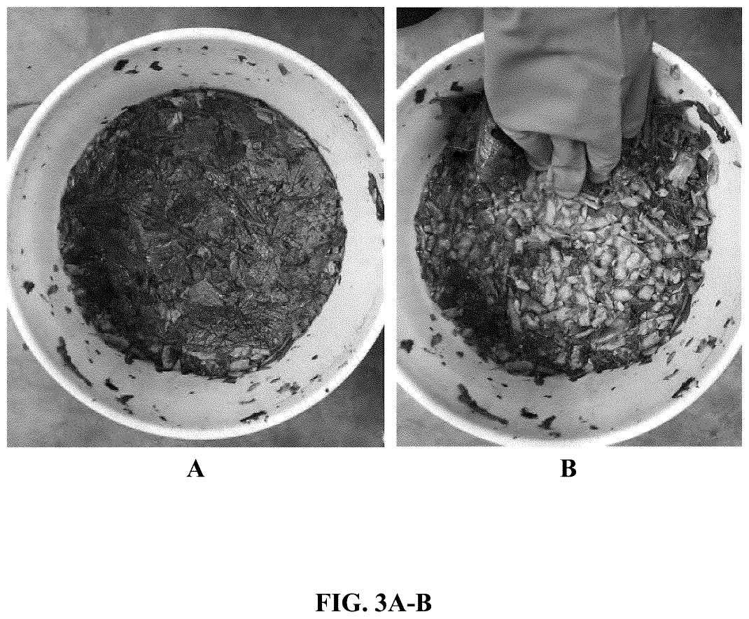

Fermented Bucket #3 was opened on Jan. 16, 2023. Upon opening, this fermentation had an appearance as shown in FIG. 3A-B. Upon unsealing, pH of the fermentate was 4.0 as measured with a handheld pH meter.

Upon unsealing, the fermentate appeared green, was very wet (no effluent was removed during the fermentation) and had a smell of vinegar and/or pickled substances.

### Example 4—Fermentate Analysis

Of interest was whether fermentate had a composition suitable for a fertilizer. To determine this, forage analysis was performed on the two silages by Cumberland Valley Analytical Services (CVAS) of Waynesboro, Pennsylvania. The data are shown in TABLE 4, below.

TABLE 4
Forage Analysis^{c} of Silages
Chemistry Analysis Results

| Moisture | 91.1^{a}/89.3^{b} |
|---|---|
| Dry Matter | 8.9/10.7 |

Proteins

| | % SP | % CP | % DM |
|---|---|---|---|
| Crude Protein | | | 15.3/10.4 |
| Adjusted Protein | | | 15.3/10.4 |
| Soluble Protein | | 66.0/57.9 | 10.1/6.0 |
| Ammonia (CPE) | 37.6/26.1 | 24.8/15.1 | 3.79/1.57 |
| ADF Protein (ADICP) | | 6.5/4.5 | 1.00/0.47 |
| NDF Protein (NDICP) | | 7.4/4.8 | 1.13/0.50 |

Fiber

| | % NDF | % DM |
|---|---|---|
| ADF | 56.4/87.4 | 14.2/17.6 |
| aNDF | | 25.2/20.1 |
| Lignin | 10.29/9.17 | 2.60/1.85 |

Carbohydrates

| | % NFC | % DM |
|---|---|---|
| Silage Acids | 34.5/18.1 | 14.4/10.0 |
| Ethanol Soluble CHO (ESC-Sugar) | 13.6/22.1 | 5.7/12.2 |
| Starch | 0.2/6.0 | 0.1/3.3 |
| Soluble Fiber | 57.5/55.9 | 24.06/30.94 |
| Crude Fat | | 2.10/2.28 |

Minerals

| | |
|---|---|
| Ash (% DM) | 16.7/12.39 |
| Calcium (% DM) | 2.61/1.47 |
| Phosphorus (% DM) | 0.53/0.51 |
| Magnesium (% DM) | 0.27/0.21 |
| Potassium (% DM) | 3.07/2.65 |
| Sulfur (% DM) | 0.62/0.44 |
| Sodium (% DM) | 0.22/0.23 |
| Chloride (% DM) | 0.29/0.37 |
| Iron (PPM) | 1930/1899 |
| Manganese (PPM) | 132/78 |
| Zinc (PPM) | 56/60 |
| Copper (% DM) | 9/7 |

Fermentation

| | |
|---|---|
| pH | 4.76/4.11 |
| Total VFA | 12.98/9.98 |
| Lactic Acid (% DM) | 9.60/7.70 |
| Lactic Acid as % of Total VFA | 74/77 |
| Acetic Acid (% DM) | 3.38/2.28 |
| Propionic Acid (% DM) | 1.16/ND |
| Nitrate Ion (% DM) | 0.05/0.04 |
| Nitrate-Nitrogen (PPM) | 108/81 |

Energy & Index Calculations

| | |
|---|---|
| TDN (% DM) | 63.0/70.5 |
| Net Energy Lactation (Mcal/lb) | 0.65/0.73 |
| Net Energy Maintenance (Mcal/lb) | 0.67/0.80 |
| Net Energy Gain (Mcal/lb) | 0.40/0.52 |
| ME (Mcal/lb) | 1.07/1.22 |
| Non-Fiber Carbohydrates (% DM) | 41.8/55.3 |
| Non-Structural Carbohydrates, ESC (% DM) | 5.8/15.5 |
| DCAD (meq/100 gdm) | 41.2/39.6 |

^{a}Data for the silage unsealed on Dec. 13, 2022 are before the slash.
^{b}Data for the silage unsealed on Jan. 16, 2023 are after the slash.
^{c}www.foragelab.com/Services/Forage-and-Feed/Chemistry/

Additionally, CVAS tested for mold and yeast in the fermentate (see www.foragelab.conVServices/Forage-and-Feed/Mold-and-Yeast-Evaluation/). For the fermentate unsealed on December 13, there were <1,000 CFU of mold/gram silage and 1,000 CFU of yeast/gram silage. For the fermentate unsealed on Jan. 16, 2023, there were <1,000 CFU of mold/gram silage and <1,000 CFU of yeast/gram fermentate.

For the fermentate unsealed on Bucket #1 on December 13, CVAS performed an amino acid analysis of proteins in the silage. For the analysis, acid hydrolysis used the modification of Gehrke (JAOAC 68:811-821, 1985), performic acid peroxidation for sulfur-containing amino acids used the modification of Manson (ZTierphysio, Tieremahrg u Futtermttelkde 43: 143-146, 1980; Elkin and Griffith, JAOAC 68:1117-1121, 1985), alkaline hydrolysis used the method of Landry and Delhaye (J Agr Food Chem 40:776-779, 1992), and HPLC methods used a post-column with ninhydrin derivatization (AOAC: 994.12). The data from the amino acid analysis is shown in TABLE 5.

TABLE 5
Amino Acid Analysis of Fermentate^{d}

| Amino Acid | W/W %^{a} As Received | W/W %^{a} Dry Matter Basis |
|---|---|---|
| Cysteine | 0.02 | 0.19 |
| Methionine | 0.02 | 0.17 |
| Lysine | 0.02 | 0.25 |
| Alanine | 0.06 | 0.66 |
| Aspartic Acid | 0.06 | 0.63 |
| Glutamic Acid | 0.06 | 0.69 |
| Glycine | 0.04 | 0.48 |
| Isoleucine | 0.04 | 0.40 |
| Leucine | 0.06 | 0.66 |
| Proline | 0.05 | 0.53 |
| Threonine | 0.03 | 0.36 |
| Valine | 0.06 | 0.63 |
| Arginine | 0.02 | 0.23 |
| Histidine | 0.02 | 0.23 |
| ^{b}Ornithine | 0 | 0 |
| Phenylalanine | 0.07 | 0.82 |
| Serine | 0.03 | 0.29 |
| Tyrosine | 0.02 | 0.27 |
| Tryptophan | 0.01 | 0.13 |
| Total | 0.7 | 7.6 |
| Crude protein^{c} | 1.4 | 15.3 |
| (Nitrogen % × 6.25) | | |
| AA nitrogen as % of | 40.4 | |
| total nitrogen | | |

^{a}W/W % is grams per 100 grams of sample. The sample had 8.9% dry matter.
^{b}Ornithine is a non-protein amino acid found in meat, fish, dairy and eggs.
^{c}Crude protein determined by combustion analysis and reported as N % × 6.25.
^{d}www.foragelab.com/Services/Forage-and-Feed/Amino-Acids/

### Example 5—Additional Fermentate Analysis

Of interest was whether the fermentate had a composition suitable for a fertilizer. To determine this, the silage was tested similarly to manure and fertilizers. The results are shown in TABLE 6, below.

TABLE 6
Manure-Type Analysis of Fermentate^{a,b,c}
Analyte^{d}

| | % (Wet-Basis) | Lbs/1000 Gal | Lbs/Ton |
|---|---|---|---|
| Solids | 9.49/8.41 | | |
| Moisture | 90.5/91.6 | | |
| Total Nitrogen | 0.18/0.18 | 15.3/14.7 | 3.66/3.52 |
| Ammonium Nitrogen | 0.017/0.025 | 1.42/2.09 | 0.34/0.5 |
| Organic Nitrogen | 0.17/0.15 | 13.8/12.6 | 3.22/3.02 |
| P₂O₅ | 0.113/0.104 | 9.41/8.64 | 2.25/2.07 |
| K₂O | 0.3/0.26 | 24.6/21.2 | 5.9/5.09 |
| P | 0.049/0.045 | 4.09/3.76 | 0.98/0.9 |
| K | 0.25/0.21 | 20.5/17.7 | 4.92/4.24 |

^{a}Analysis done on an “as received/wet” sample
^{b}www.foragelab.com/Services/Manure/Example-Reports/
^{c}pH of the sample was 4.08.
^{d}Data for fermentate unsealed on Dec. 13, 2022 are before the slash; data for silage unsealed on Jan. 16, 2023 are after the slash.

### Example 6—Fermentate as Substitute for Manure Fertilizer

Use of manure as a fertilizer or substitute for fertilizer likely began 8,000 years ago and continues to this day (Bogaard, Amy, et al. “Crop manuring and intensive land management by Europe's first farmers.” Proceedings of the National Academy of Sciences 110.31, 2013: 12589-12594). We compared the turnip fermentate with various manures as a way to determine suitability of the turnip fermentate for use as a fertilizer.

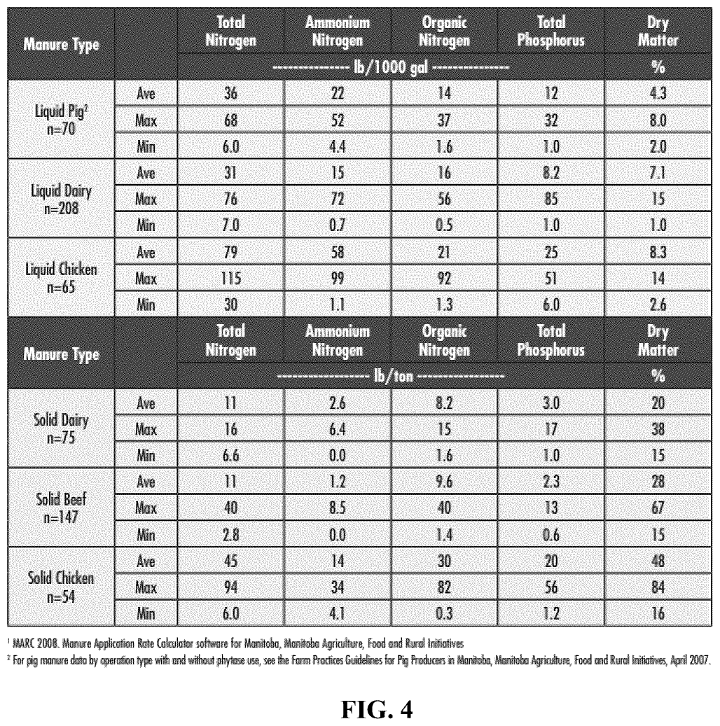

We first referenced a factsheet published by the Province of Manitoba, titled “Manure Management Facts, Calculating Manure Application Rates,” dated January 2009, which is available here: www.gov.mb.ca/agriculture/environment/nutrient-management/pubs/mmf_calcmanureapprates_factsheet.pdf. On page 3 of that publication, there is a table titled “Nitrogen, Phosphorus and Moisture Contents of Various Manures” which illustrates total nitrogen, ammonium nitrogen, organic nitrogen and total phosphorus of various manures in lbs/1000 gallons. The dry matter content of the various manures is also shown. That table is reproduced in FIG. 4 of this application.

In comparing the data for the turnip silage shown in TABLE 6 (14-15 lbs/1000 gal total nitrogen, 1-2 lbs/1000 gal ammonium nitrogen, 12-14 lbs/1000 gal organic nitrogen, 8-10 lbs phosphate) with the manures in FIG. 4, the turnip silage disclosed herein has a total nitrogen and ammonium nitrogen content similar to liquid dairy manure. The turnip silage has an organic nitrogen content similar to liquid pig manure. The turnip silage has a total phosphorus content similar to liquid pig and liquid dairy manure. The turnip silage has a solid/dry matter content of between about 9-12% (90-92% Wet-Basis), which is most similar to the liquid manures in FIG. 4, particularly similar to liquid dairy or liquid chicken manure. We conclude that the turnip silage can be used as a fertilizer.

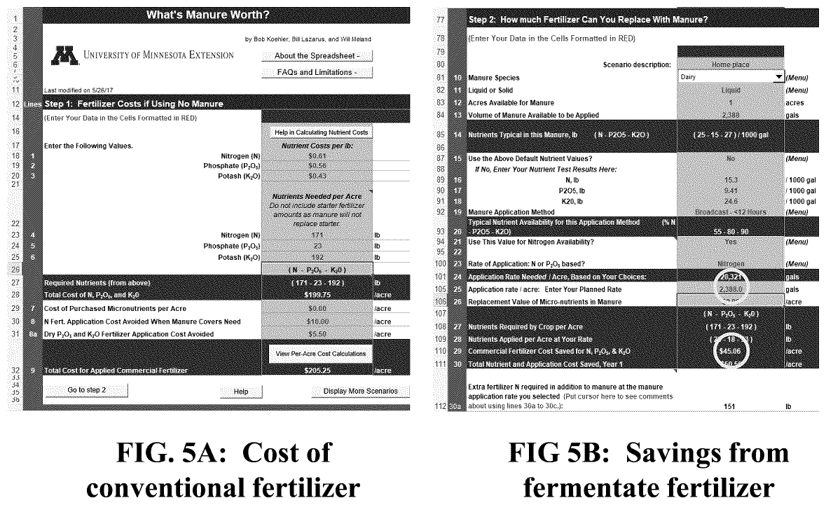

We also referenced a University of Minnesota Extension website that can calculate cost savings for replacing standard fertilizers with various manures (apps.extension.umn.edu/agriculture/manure-management-and-air-quality/manure-application/calculator/). We also contacted the University of Minnesota Extension and they sent us the spreadsheet program, used on the previously mentioned website. Using this spreadsheet calculator, we determined whether it would be feasible to substitute amounts of standard fertilizers with the turnip silage and whether this substitution would provide cost savings (see FIG. 5A-B). In making the calculation, we used fertilizer prices from October 2023, as stated by the Ohio Country Journal (https://ocj.com/2023/10/declining-fertilizer-prices), where Urea Nitrate (UAN) at $0.61/ton, Potash 60 at $0.48/ton, and diammonium phosphate (DAP) at $0.43/ton. We used the nutrient requirements for potatoes, with an expected yield of 400 cwt/acre (source: University of Minnesota: https://extension.umn.edu/crop-specific-needs/potato-fertilization-irrigated-soils), with requirements of 171 lb/acre Nitrogen, 23 lb/acre P₂O₅, 192 lb/acre K₂O. At these commercial chemical fertilizer prices, and the nutrient requirements of the potatoes, the University of Minnesota spreadsheet calculator calculated a fertilizer cost per acre at $205.25/acre.

To calculate the costs saved by applying the fermentate fertilizer, we input additional variables. We assumed an applied rate over 1 acre of 2388 gal/acre; the same rate we applied our fermentate fertilizer over a patch of potatoes in 2023 (74 lbs/225 sqft) (See Example 7 and FIG. 5A-B soil results and discussion). We then used the CVAS test results from Bucket #1 turnip fermentate using pounds of nitrogen (15.3/1000 gal), phosphate (9.41/1000 gal) and potash (24.6/100 gal) from TABLE 6, as shown in FIG. 5A. We assumed our fertilizer best meets a “Liquid Dairy Manure”, from FIG. 5B. The calculation showed that the cost savings for nitrogen/phosphate/phosphorus fertilizer by using turnip salge is $45.06 per acre. If a savings of $10 per acre representing nitrogen fertilizer application cost avoided, and a savings of $5.50 per acre representing dry phosphate and potash fertilizer application cost avoided for manure is used, then the cost savings per acre for using turnip silage is $50.56 from FIG. 5B. Therefore, use of the turnip silage represents significant savings over using fertilizer (ocj.com/2023/10/declining-fertilizer-prices/; www.farmprogress.com/crops/starter-fertilizer-yes-or-no-; extension.umn.edu/crop-specific-needs/potato-fertilization-irrigated-soils).

### Example 7—Fermentate and Soil

In June 2023, a section of garden was separated into two sections. Section one (1) would be the “control”, with no fertilizer added and Section two (2) would be the “test”, with fertilizer added. Soil was sampled in Section 1 and Section 2 before any activities or additions of fermentate fertilizer on 16 Jun. 2023 (see TABLE 7, 16 Jun. 2023). These soil samples were sent to Brookside Labs for analysis to establish the initial baseline nutrient content of each Section.

After soil was sampled in both sections, Section 2 received approximately 74 lbs of fermentate (solid matter and effluent), more or less evenly distributed across a 5 ft by 45 ft area (entire area of Section 2) and then mechanically incorporated into the soil with a Bush Hog RT60G tiller. Section 1 did not receive fermentate. 50 Yukon Gold potatoes were planted into Section 2. Section 1 also received 50 Yukon Gold potatoes. On 28 Jul. 2023, another series of soil tests were performed from soil samples from Section 1 and Section 2, 28 Jul. 2023 (see TABLE 7).

TABLE 7
Soil Reports

| | Garden Location & Sample Date | | | |
|---|---|---|---|---|
| | Section 1 | Section 1 | Section 2 | Section 2 |
| | 16 Jun. | 28 Jul. | 16 Jun. | 28 Jul. |
| | 2023 | 2023 | 2023 | 2023 |
| Total exchange capacity | 13.88 | 8.71 | 14.68 | 8.20 |
| (ME/100 g) | | | | |
| pH in buffer^{a} | 7.0 | 7.1 | 7.0 | 7.0 |
| pH in H₂O^{b} | 6.1 | 6.2 | 6.1 | 5.8 |
| Organic matter^{c} (%) | 9.02 | 7.64 | 8.40 | 7.97 |
| Estimated nitrogen | 120 | 113 | 117 | 115 |
| release (lb/A) | | | | |
| Soluble sulfur⁶ (ppm) | 15 | 16 | 15 | 23 |
| Phosphorus^{4,6} (1b/A) | 197 | 128 | 137 | 156 |
| Phosphorus^{5,6} (ppm) | 43 | 28 | 30 | 34 |
| Calcium⁶ (lb/A) | 3828 | 2174 | 4136 | 1900 |
| Calcium⁶ (ppm) | 1914 | 1087 | 2068 | 950 |
| Magnesium⁶ (lb/A) | 318 | 362 | 282 | 200 |
| Magnesium⁶ ppm) | 159 | 181 | 141 | 100 |
| Potassium⁶ (lb/A) | 250 | 168 | 284 | 268 |
| Potassium⁶ (ppm) | 125 | 84 | 142 | 134 |
| Sodium⁶ (lb/A) | 30 | 26 | 26 | 36 |
| Sodium⁶ (ppm) | 15 | 13 | 13 | 18 |

Base Saturation Percent

| | | | | |
|---|---|---|---|---|
| Calcium (%) | 68.95 | 62.40 | 70.44 | 57.93 |
| Magnesium (%) | 9.55 | 17.32 | 8.00 | 10.16 |
| Potassium (%) | 2.31 | 2.47 | 2.48 | 4.19 |
| Sodium (%) | 0.47 | 0.65 | 0.39 | 0.95 |
| Other bases (%) | 5.20 | 5.20 | 5.20 | 5.80 |
| Hydrogen (%) | 13.50 | 12.00 | 13.500 | 21.00 |

Extractable Minors

| | | | | |
|---|---|---|---|---|
| Boron⁶ (ppm) | 0.30 | 0.27 | 0.29 | 0.25 |
| Iron⁶ (ppm) | 187 | 185 | 203 | 191 |
| Manganese⁶ (ppm) | 11 | 10 | 9 | 8 |
| Copper⁶ (ppm) | 1.55 | 1.33 | 1.75 | 1.41 |
| Zinc⁶ (ppm) | 1.40 | 1.22 | 1.29 | 1.44 |
| Aluminum⁶ (ppm) | 2161 | 1705 | 2243 | 1665 |
| NO₃—N (ppm) | 29.8 | 14.5 | 24.4 | 18.5 |
| NH₄—N (ppm) | 1.0 | 2.8 | 1.9 | 7.5 |

¹SMP/Sikora
²1:1
³360° C. LOI
⁴P as P₂O₅
⁵ppm of P
⁶Mehlich III extractable

The data indicate an increase in phosphorus from June 16 to July 28 in Section 2 due to addition of the fermentate, while phosphorus declined from June 16 to July 28 in Section 1. Potassium decreases slightly in Section 2 from June 16 to July 28 with fermentate, while there was a more pronounced decrease in potassium in Section 1 during the same time period. Ammonium nitrogen increased between June 16 and July 28 in both Sections 1 and 2. However, the increase was greater in Section 2, where the fermentate was added. Organic matter decreased in both Sections 1 and 2, but decreased less in Section 2, where the fermentate was added. These data indicate plant-available nutrients were added to the soil, when the fermentate was incorporated into Section 2.

It was also observed that the potatoes planted in Section 2 sprouted earlier (14 Jun. 2023) than those planted in Section 1 (at least 3 days later). This is likely due to the higher amount of plant-available phosphorus in Section 2, as phosphorus is the first nutrient ingested by potatoes and is responsible for initial growth. The soil phosphorus increase is directly attributable to both the addition of fermentate soluble phosphorus nutrients, the source of which was the original harvested turnip, and the fermentate lactic acid, which acted on the soil organic phosphorus and solubilized these compounds into plant-available compounds.

### Example 8—Microbes in the Fermentate

To identify microbes present in the fermentation produced by the disclosed process, at the conclusion of one of the fermentations described in Examples 1-3, some of the fermentate was analyzed using DNA sequencing. Bioinformatics analysis of the determined sequences was used to determine the identity of bacteria in the fermentate. The relative number of sequence reads in the study was used to determine relative proportions of the bacteria in the silage. This study was performed as described below.

At the completion of one of the fermentations described in Examples 1-3, some of the fermentate from Bucket #3 was set to Exact Scientific Services, Inc., (ESS) in Femdale, Washington to perform non-targeted whole sample DNA sequencing. Sequences were analyzed using the ESS bioinformatics pipeline microbes (see www.exactscientific.con/dna-services.html). In this sequencing method, the number of sequencing reads is roughly proportional to the number of microbes in the sample. The data in the Table 8 identify the ten most frequent microbes in the sample.

TABLE 8
Microbes in Silage

| Genus | Species | No. of Reads |
|---|---|---|
| Serratia | plymuthica | 23,760 |
| Rahnella | aquatilis | 19,751 |
| Lelliottia | amnigena | 11,581 |
| Rahnella | inusitata | 10,497 |
| Rahnella | aceris | 3,879 |
| Latilactobacillus | sakei | 3,427 |
| Rahnella | victoriana | 2,902 |
| Serratia | fonticola | 2,393 |
| Leuconostoc | mesenteroides | 2,031 |
| Erwinia | rhapontici | 1,761 |

Latilactobacillus sakei is a homofermentative lactic acid bacterium.

We note that Leuconostoc mesenteroides is a heterofermentative lactic acid bacterium.

We note that Rahnella aquatilis can convert insoluble phosphorus and potassium to a soluble form.

We note that Leuconostoc mesenteroides is a bacterium known in fermentation of cabbage to produce sauerkraut that produces CO₂ and facilitates lowering the pH so that Lactobacillus/Latilactobacillus bacteria can further the fermentation.

We note that Serratia plymuthica is a known phosphorus, potassium, and zinc solubilizing bacteria.

### Example 9—Adding Cultures of Homofermentative Lactic Acid Bacteria to a Fermentation

A culture (e.g., inoculant or starter culture) of one or more homofermentative lactic acid bacteria is prepared. The culture(s) are added to a fermentation as described in Example 2.

### Example 10—Adding a CO₂ Scavenger to a Fermentation

A CO₂ scavenger is added to a fermentation as described in Example 2.

### Example 11—Adding a Bacterium that Utilizes CO₂ to a Fermentation

A bacterium that utilizes CO₂ is added to a fermentation as described in Example 2.

### Example 12—Adding Nitrogen Fixing, Phosphorus Solubilizing, and/or Potassium Solubilizing Bacteria to a Fermentation

Nitrogen fixing, phosphorus solubilizing and/or potassium solubilizing bacteria are added to a fermentation as described in Example 2.

### Example 13—Fermenting Hemp Nettle and Fireweed (“Weeds”)

In summer of 2023, Fireweed (Chamerion angustifolium) and hemp nettle (Galeopsis tetrahit), as State of Alaska-designated noxious weed, were chopped into pieces similar to those of the turnips (FIG. 1C). Two fermentations were performed for each of the fireweed and hemp nettle, in buckets as described for turnips in Example 2. In one bucket for each of fireweed and hemp nettle, 2 cups water and a small amount of dissolved brown sugar were added. In the other bucket for each of fireweed and hemp nettle, no additions were made. The buckets were sealed and handled as described in Example 2.

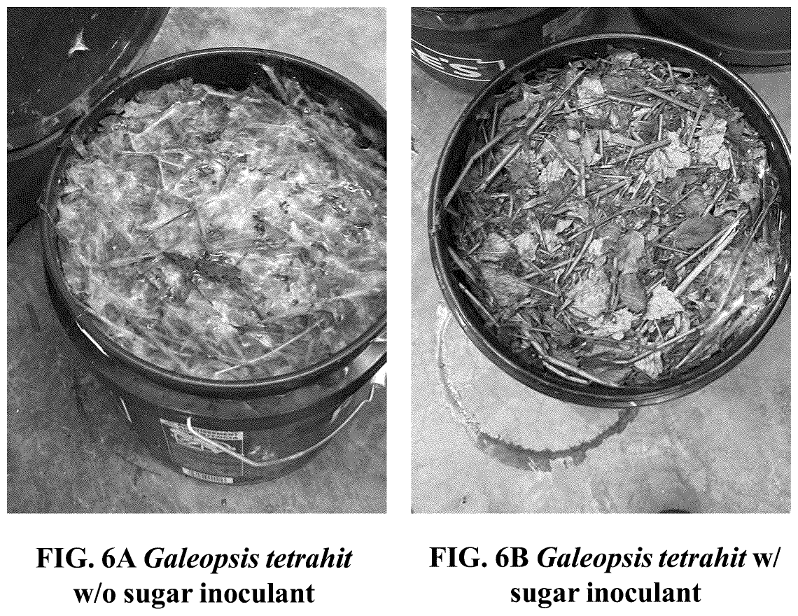

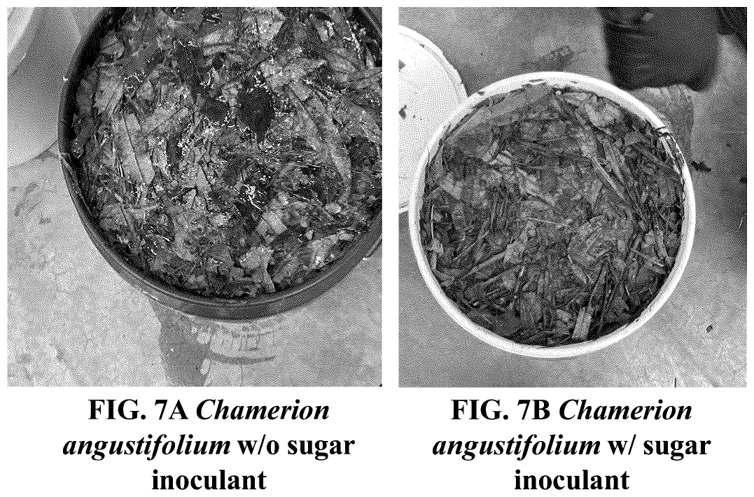

In the buckets with no additions, no noticeable fermentation occurred. In the buckets to which water and brown sugar were added, fermentation occurred. No gas accumulation was observed during the fermentation. The smell of Fireweed fermentate had a faint pine smell. The smell from hemp nettle was not detectable. FIG. 6A-B and FIG. 7A-B show the results of w/sugar and w/o sugar inoculation, for both hemp nettle (Galeopsis tetrahit) and fireweed (Chamerion angustifolium).

A fermentation profile was performed on the hemp nettle fermentate by Cumberland Valley Analytical Services. The data are shown in TABLE 9 below.

TABLE 9
Fermentation Analysis Results of Hemp Nettle

| | | Dry Matter Basis | Observed Range |
|---|---|---|---|
| Analytical | Dry Matter | 16.7 | |
| Results | pH | 4.60 | 4.2-5.3 |
| | Ammonia | 4.18% DM | 3.4-12.0 |
| | Total VFA | 4.61% DM | |
| | Lactic Acid | 60.7% Total VFA | 50.0-88.5 |
| Lactic Acid and | Lactic Acid | 2.80% DM | |
| Volatile | Acetic Acid | 1.81% DM | |
| Alcohols | Methanol | 0.18% DM | |
| | Ethanol | 2.93% DM | |

The data show production of lactic acid and acetic acid. An alcohol analysis indicated low amounts of ethanol and methanol.

Manure-type analyses, like those shown in Example 5, were performed on both the fireweed (TABLE 10) and hemp nettle (TABLE 11) fermentates.

TABLE 10
Manure-Type Analysis of Fireweed Fermentate^{a,b}
Analyte

| | % (Wet-Basis) | Lbs/1000 Gal | Lbs/Ton |
|---|---|---|---|
| Solids | 23.1 | | |
| Moisture | 76.9 | | |
| Total Nitrogen | 0.46 | 38.1 | 9.14 |
| Ammonium Nitrogen | 0.003 | 0.25 | 0.06 |
| Organic Nitrogen | 0.45 | 37.9 | 9.08 |
| P₂O₅ | 0.145 | 12.1 | 2.90 |
| K₂O | 0.4 | 33.2 | 7.94 |
| Ca | 0.21 | 17.4 | 4.18 |
| Mg | 0.047 | 3.92 | 0.94 |
| Na | 0.008 | 0.67 | 0.16 |
| P | 0.063 | 5.26 | 1.26 |
| K | 0.33 | 27.6 | 6.62 |

| | mg/kg | Lbs/1000 Gal | Lbs/Ton |
|---|---|---|---|
| Cu | 1.84 | 0.015 | 0.0037 |
| Mn | 29.6 | 0.25 | 0.059 |
| Fe | 38.4 | 0.32 | 0.077 |
| Zn | 5.51 | 0.046 | 0.011 |
| Total Carbon | 10.9 | | |
| Carbon/Nitrogen | 23.6 | | |
| Ratio | | | |

^{a}Analysis done on an “as received/wet” sample
^{b}www.foragelab.com/Services/Manure/Example-Reports/

TABLE 11
Manure-Type Analysis of Hemp Nettle Fermentate^{a,b}
Analyte

| | % (Wet-Basis) | Lbs/1000 Gal | Lbs/Ton |
|---|---|---|---|
| Solids | 17 | | |
| Moisture | 83 | | |
| Total Nitrogen | 0.47 | 38.8 | 9.3 |
| Ammonium Nitrogen | 0.017 | 1.42 | 0.35 |
| Organic Nitrogen | 0.45 | 37.4 | 8.96 |
| P₂O₅ | 1.165 | 13.8 | 3.31 |
| K₂O | 0.56 | 47 | 11.3 |
| Ca | 0.16 | 13.6 | 3.26 |
| Mg | 0.045 | 3.76 | 0.9 |
| Na | 0.006 | 0.5 | 0.12 |
| P | 0.072 | 6.01 | 1.44 |
| K | 0.47 | 39.2 | 9.38 |

| | mg/kg | Lbs/1000 Gal | Lbs/Ton |
|---|---|---|---|
| Cu | 1.49 | 0.012 | 0.003 |
| Mn | 16.8 | 0.14 | 0.34 |
| Fe | 61.3 | 0.51 | 0.12 |
| Zr | 4.79 | 0.04 | 0.0096 |
| Total Carbon | 7.24 | | |
| Carbon/Nitrogen | 15.4 | | |
| Ratio | | | |

^{a}Analysis done on an “as received/wet” sample
^{b}www.foragelab.com/Services/Manure/Example-Reports/

These data indicate, that in terms of solubilized phosphate (P₂O₅) and solubilized potassium (K₂O), the fermentates from fireweed and hemp nettle are as good or better than the turnip fermentates.

### Example 14—Fermentate-as-Herbicide

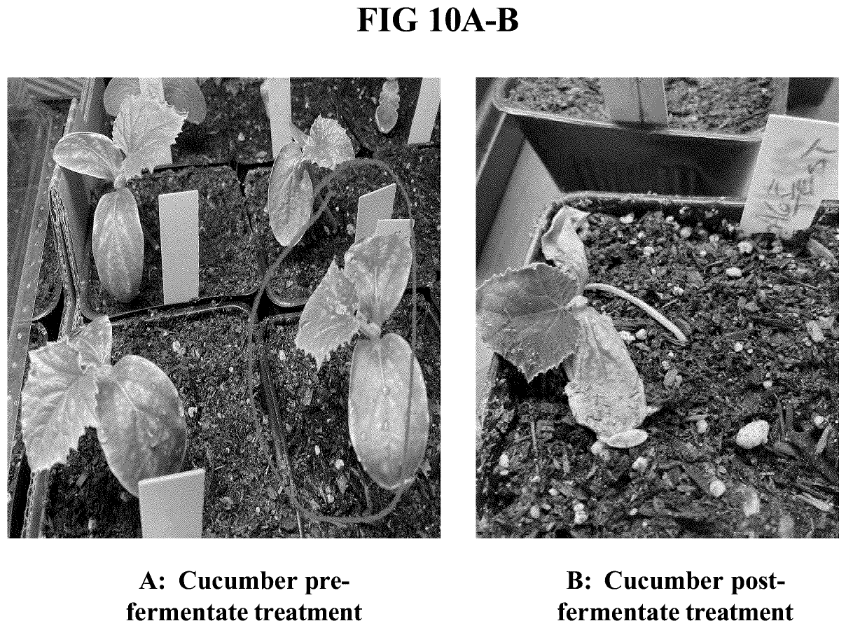

On 15 Apr. 2023, we applied fermentate from Bucket #3 (2 Oct. 2022) onto a seedling cucumber (FIG. 10A-B). The cucumber rapidly wilted and died within hours. Acetic acid content was 2.28% DM. Acetic acid, when applied to broadleaf plants, rapidly disrupts the cell walls of plants. The plants dehydrated and expired: (www.portlandoregon.gov/shared/cfm/image.cfm?id=165709).

To confirm the effect of the fermentate was consistent with acetic acid, we applied commercial acetic acid (household vinegar) to another cucumber seedling. We observed the same effect(s). We replanted cucumber seeds in the same seedling pots, to ensure the effects of fermentate were not permanent. By 4 May 2023, cucumber seedlings had reappeared, and the plants grew normally thereafter.

The fermentation results, combined with direct observations after applying the fermentate to the surface of the cucumbers, indicate the fermentate is a very effective contact herbicide, consistent with the effects of acetic acid when applied to broadleaf plants.

### Example 15—Lactic Acid as a Soil Inoculant/Amendment as a Nutrient Booster

Lactic acid is well understood as a solubilizing agent for organic phosphorus and potassium compounds (plant unavailable nutrients), and transforms them into inorganic, plant-available nutrients (University of Malaysia; www.frontiersin.org/articles/10.3389/fpls.2022.1047945/full). Industrially-produced lactic acid is expensive to produce. As a result, it is cost-prohibitive for farmers to use it as a soil inoculant/nutrient booster for agricultural use.

Fermenting plants in the methods described within this application, and in particular, whole-plant root crops (leaf and root together), provide an economical method to produce quantities of lactic acid for the purpose of soil nutrient boosting.

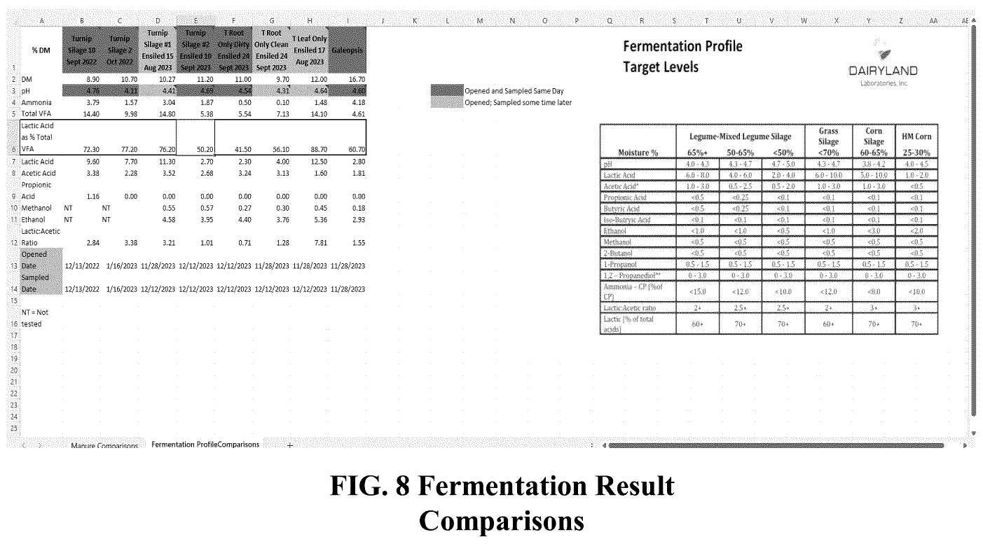

As evidenced by the results of two years of fermentation testing of whole-plant purple top turnip in FIG. 8, there is a consistent pattern of delivery of high amounts of lactic acid. This is due to the combined and competing effects between the high-sugar root, which offers the ideal growth substrate for the lactic acid bacteria, and the high nitrogen and calcium leaf, which offers a buffering effect to delay a rapid drop in pH and thus, allow the lactic acid bacteria to survive longer and produce more lactic acid. The root-only fermentates show levels of lactic acid much less than their counterparts, due to the lack of buffering offered by the leaves. With nothing to contain and delay a rapid pH drop, the root-only lactic acid bacteria quickly died and thus prevented any more production of lactic acid.

Plant maturity, along with buffering capacity, also has a large impact on the amount of lactic acid produced during fermentation. The only outlier of the results in FIG. 8 is the 10 Sep. 2023 fermentation of whole-plant purple top turnip. These particular 2023 plants were “volunteer” turnips, that grew from seeds which did not sprout from a 2022 planting. Their growth period was likely at least 130 or more days, far longer than the other deliberate plantings in 2022 and 2023 (NOTE: in 2022 there was a drought, and the turnips did not begin to grow until 17 Jul. 2022, when the drought was lifted.) With wheat and maize at later stages of maturity, there is less success at fermentation, due to decreasing carbohydrate availability and increasing fiber and lignin: (www.sciencedirect.com/science/article/abs/pii/S0377840114003460) (www.ncbi.nlm.nih.gov/pmc/articles/PMC4093009/).

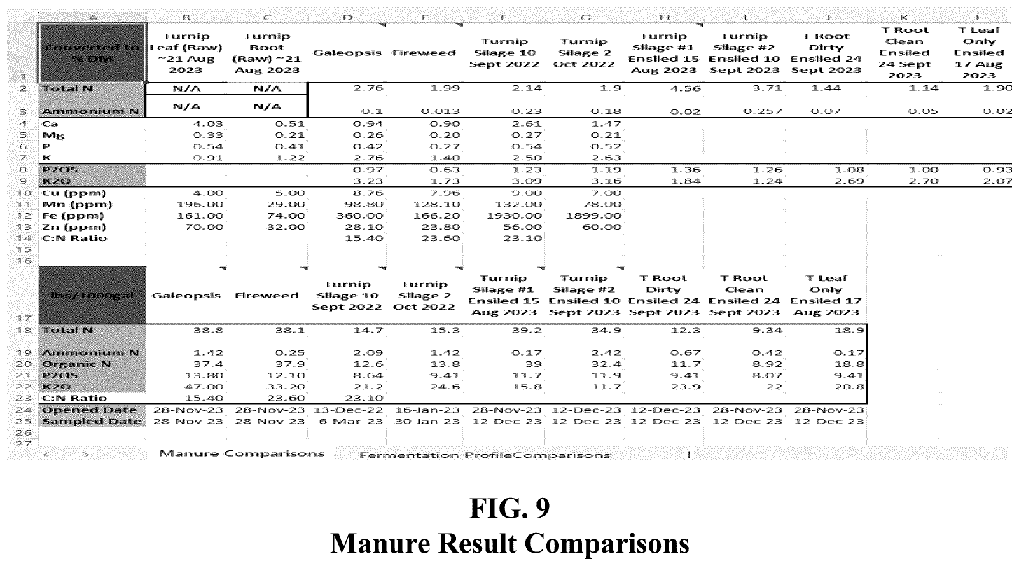

Despite the results of the 10 Sep. 2023 fermentate, the other fermentate results of whole-plant purple top turnip, as well as purple top leaf-only fermentate, were very high, compared to the expectations in the Dairyland reference chart in FIG. 8. Of note with the purple top leaf-only fermentation results in FIG. 8, the turnip leaf offers a substantial amount of protein (for buffering) and sugars (for LAB nutritional requirements) and does not require sugar inoculant, when harvested at maturity or earlier. The results outlined in FIG. 8 demonstrate a very high amount of lactic acid generated, due to these factors. The implications of these factors and their results is that it offers the option to the farmer of harvesting the root, and selling it as a food source, and simultaneously fermenting the leaf for the lactic acid soil amendment and fertilizer component(s) (as shown in FIG. 9).

TABLE 7 soil reports show an increase in plant available phosphorus, well above the soil phosphorus levels originally measured prior to fermentate application. While the fermented purple top turnips offered an outside (or foreign) source of new soluble phosphorus and potassium, as indicated in the manure results, the lactic acid offered an additional capability to solubilize the already present, or “native”, organic phosphorus and potassium in the soil. Our fermentate method offers two different, yet inseparable, pathways to enable access to plant available phosphorus and potassium.

### Example 16—Carbon Capture and Carbon Sequestration Via Fermentate Fertilizer Methods

The College of Agriculture at the University of Osaka published a paper in October 2002, whereby they determined the carbon dioxide capture capacity (and oxygen production capacity) of turnips, within a 6-day period of the turnip life cycle, at growth days 24-30. They determined a single turnip will consume/capture 32.0 g of carbon dioxide and release 25.3 g of oxygen, during these 6 days. Assuming turnips are planted 6 inches apart, in a one-acre field, the amount of carbon dioxide captured during this six-day period would be 6.14 tons (imperial) and 4.85 tons (imperial) oxygen released into the atmosphere. Assuming a straight-line increase in the ability of the turnip to capture carbon dioxide and release oxygen, a 90-day period would result in 55.7 tonnes (metric) carbon dioxide captured and 40.8 tonnes (metric) oxygen released, in this acre of turnips (see FIG. 11). NOTE: more than likely, the carbon dioxide consumption of a turnip will be more of a curved rate, vs straight line, over this period of time. Regardless, the amount of carbon dioxide captured by turnips is substantial, given the space needed and time needed to accomplish.

In 2022, 3 buckets of raw whole-plant purple top turnips (leaf and root) were chopped/chipped/shredded and packed into these buckets and sealed, in accordance with the steps and methods described throughout this application. In 2023, a total of 30, 5 gallon buckets of raw whole-plant purple top turnips (leaf and root), a total of 4, 5 gallon buckets of raw, root-only (2× clean samples, 2× dirty samples) purple top turnips, 2, 5 gallon buckets of raw leaf-only purple top turnips, 2, 5 gallon buckets of raw hemp nettle, and 2, 5 gallon buckets of raw fireweed were all chopped/chipped/shredded and packed into buckets and sealed, in accordance with FIG. 1. A-C and the steps and methods described throughout this application. 1 bucket each of Hemp Nettle and Fireweed were inoculated/treated with 2 cups of water and a small amount of brown sugar. The inoculated/treated hemp nettle and fireweed buckets were successfully fermented throughout (see FIG. 6B, FIG. 7B, FIG. 8 left table, and FIG. 9, bottom table), while the non-inoculated hemp nettle/fireweed fermented below the top 4″ of the material (FIG. 6A and FIG. 7A).

DNA results of samples from 2022 (see TABLE 8) indicate the presence of heterofermentative (Leuconostoc mesenteroides) and homofermentative (Latilactobacillus sakei) lactic acid bacteria. The three buckets from 2022 each needed a slight “burp” to release gases within the first week or so (see TABLE 3). The presence of the bacteria, and the resulting actions of “burping”, indicates and explains a likely (slight) buildup of carbon dioxide. The buckets were not weighed, after the burping. But any change in weight/mass would have been negligible and likely, not measurable without highly sensitive equipment.

None of the 30 buckets produced in 2023 were “burped”. Around 5 buckets showed a bulge in the lid, indicating a buildup of pressure. Pressure buildup obviously ceased or the lids or the seals would have broken (none did). None of the remaining 25 showed any gas buildup. Without DNA testing, we cannot confirm or deny the reactions were solely homofermentative. But the lack of gas indicates at least a predominant homofermentative reaction. Nevertheless, any amount of carbon dioxide created was negligible.

All buckets tested in 2022 and 2023 demonstrated successful fermentations (see FIG. 8) and successful nutrient results (see FIG. 9).

Given the negligible amount(s) of gases formed from 2 years of different fermentations, we can reasonably conclude that the fermentate methods we have employed result in retaining the vast majority of carbon contained in the raw plants at harvest. Given the capacity of carbon dioxide capture of turnips, our methods result in substantial carbon capture, whether the process is heterofermentative or homofermentative. If the process is predominantly or exclusively homofermentative, the carbon capture retention (along with lactic acid generation) will be maximized. The steps required to do the fermentate fertilizer result in carbon capture.

The fertilizer fermentate provides a large source of carbon as a soil amendment, in addition to the production of soluble nutrients and lactic acid. TABLE 7 shows an almost imperceptible decrease in organic matter, after the fermentate was applied. The garden side, where no fertilizer fermentate was applied, shows a larger decrease in the amount of organic matter. We can reasonably conclude when the fermentate is added and incorporated back into the soil, the majority of the carbon is retained in the soil. This step results in carbon sequestration.

We estimate the amount of diesel fuel expended to cultivate, plant, harvest, and chip/shred/chop 1 acre of turnips is approximately 3 gallons (very conservative estimate). The amount of carbon dioxide released from 3 gallons of diesel is approximately 66 lbs (of carbon dioxide).

If one acre of turnips were to be converted into fermentate fertilizer, it would require approximately 1714 plastic buckets, each weighing approximately 3 lbs apiece. The total weight in 5-gallon buckets would be 5142 lbs or 2.33 Mt (metric) per acre. Therefore, the carbon dioxide footprint of the amount of plastic to support 1 acre of turnip fermentate fertilizer is 2.33 Mt. (NOTE: even though each bucket is not pure carbon, we will treat it as so, and therefore, the amount of carbon-load per acre in buckets is actually much less than our calculations will indicate).

The amount of carbon dioxide required to produce (does not include transportation carbon dioxide “load) each metric tonne of plastic produced to the customer is 0.9 Mt (pg 26, www.ciel.org/wp-content/uploads/2019/05/Plastic-and-Climate-FINAL-2019.pdf).

Therefore, 2.33 Mt plastic 0.9 Mt CO2/1 Mt of plastic=2.097 Mt of CO₂ required by plastic per acre of turnip production (NOTE: the plastic buckets are reusable and represent a one-time cost in carbon dioxide).

The net amount of carbon dioxide captured per acre of turnips, after factoring in the carbon dioxide emitted to produce plastic, the carbon content of the plastic itself, and the diesel required to produce turnips is 53.57 Mt (imperial). (NOTE: 55.7 Mt (turnip capture)−2.097 Mt (buckets)−0.0305 Mt=34.6995 Mt CO2 captured (plus 40.8 Mt of 02 released)).

We conclude the overall carbon capture and sequestration achieved by fermentate fertilizer production (using turnips) is substantial (see FIG. 13).

### Example 17—Fermentate Fertilizer Results

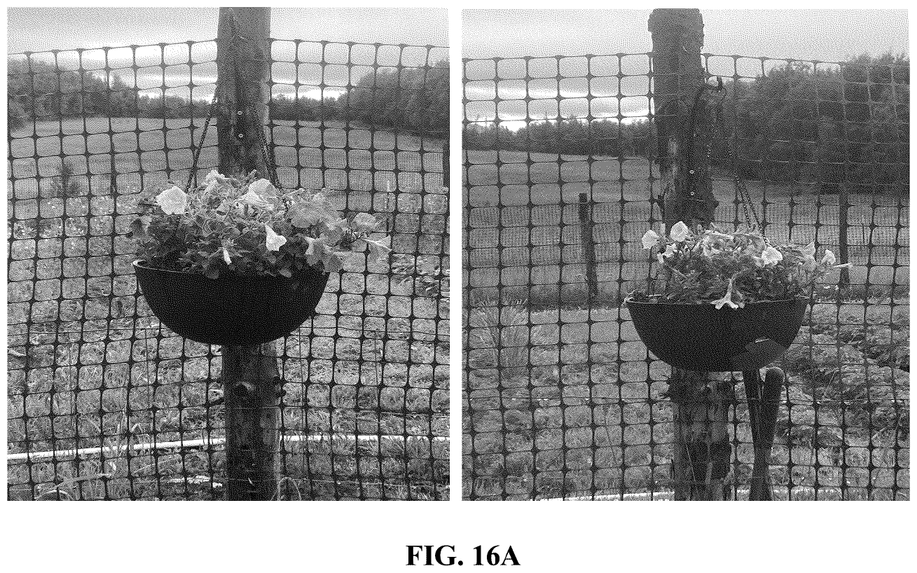

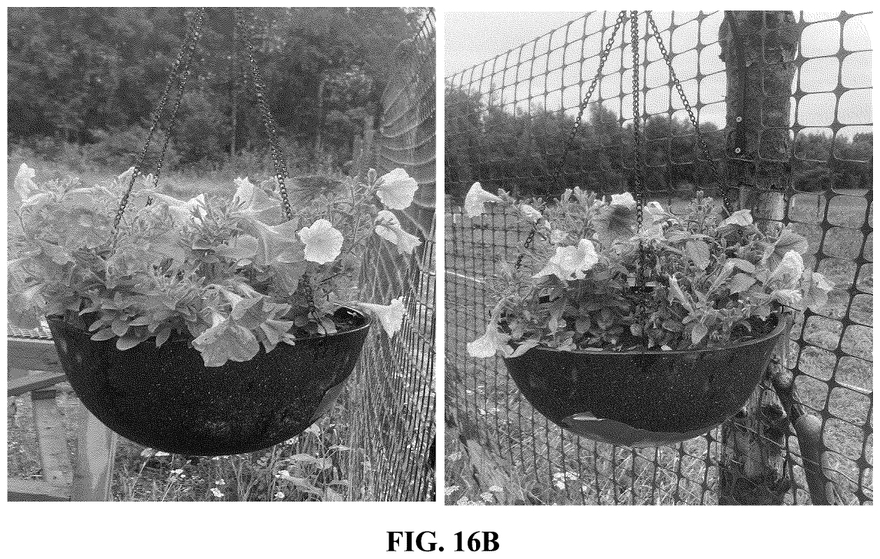

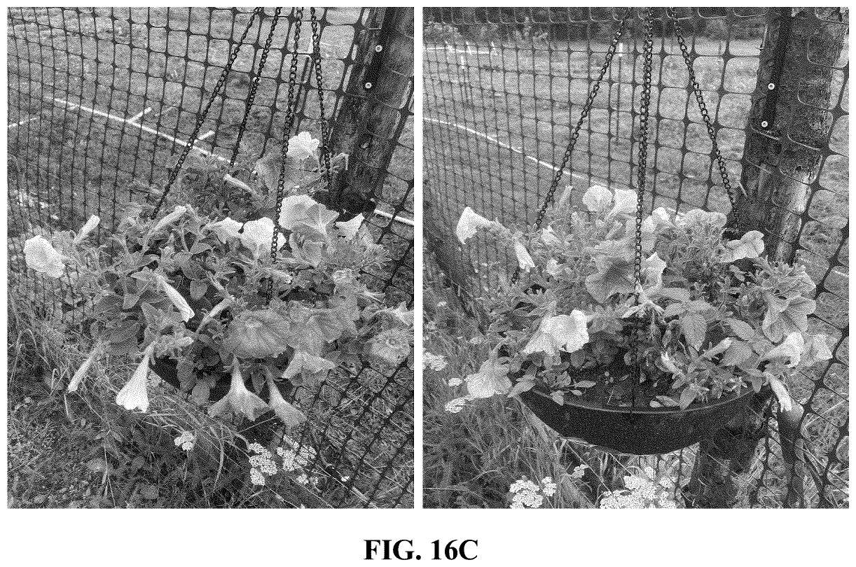

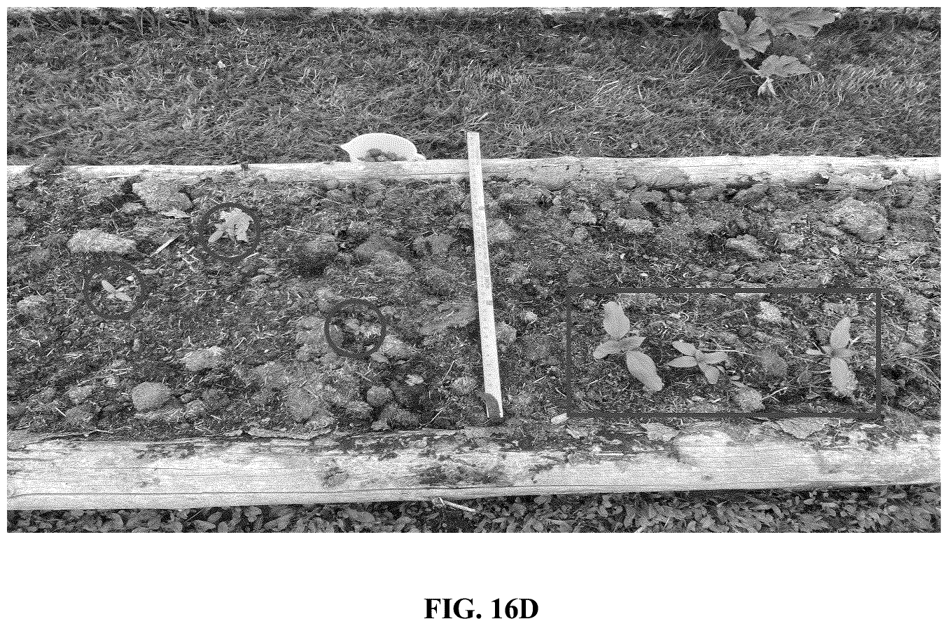

Plants were planted and grown either in the presence or absence of the fermentate described herein. The results are shown in FIG. 16A-D. Fertilizer fermentate was hand-grabbed from a 5-gallon bucket of fermentate, in the amount of one generous handful, along with ½ cup (4 fl oz) of dry granular agricultural lime, and incorporated into the soil (hand-mixed to an even consistency), in the flower pots. The plants (primarily petunias in FIG. 16A-C) were planted immediately after incorporation. No fermentate or granular lime was applied later, during the growing season. For the flower pots without fermentate, only ½ cup (4 fl oz) of dry granular agricultural lime was incorporated into the soil. After incorporation, the petunias were immediately planted. No fermentate or granular lime was applied later in the season to the non-fermentate flower pot(s).

For the sunflowers in FIG. 16D, handfuls of fermentate from a 5-gallon bucket were evenly spread (more or less) across the top of the soil to the right of the yardstick in the photograph. No granular lime was added to either the left or right of the yardstick. The soil to the right of the yardstick (with the fermentate) was incorporated by a garden hoe into the top layer of soil (estimated top 4″ or so). The soil to the left of the yardstick in the photograph was also broken up with a garden hoe. Six sunflower seeds (three on the right of the yardstick and three on the left of the yardstick) were planted immediately after these actions. No fermentate was added later into the section of the right to the yardstick for the duration of the growing season.

### EQUIVALENTS

Those skilled in the art will recognize, or be able to ascertain, using no more than routine experimentation, numerous equivalents to the specific substances and procedures described herein. Such equivalents are considered to be within the scope of this invention and are covered by the following claims.

What is claimed:

1. A method for fermenting a plant, comprising exposing the plant to an anerobic environment in the presence of homofermentative lactic acid bacteria under conditions in which fermentation by the bacteria can occur and produce a fermentate.

2. The method of claim 1, wherein the fermentate includes effluent.

3. The method of claim 1, wherein the homofermentative lactic acid bacteria are at least 10, 20, 30, 40, 50, 60, 70, 80, 90 or 99% of bacteria in the fermentate.

4. The method of claim 1, wherein a ratio of homofermentative lactic acid bacteria to bacteria capable of producing CO₂ in the fermentate is at least about 1:1, 2:1, 3:1, 4:1, 5:1, 6:1, 7:1, 8:1 or 9:1.

5. The method of claim 1, additionally comprising adding an inoculant or starter culture of homofermentative lactic acid bacteria to the plant at or around the time the plant is exposed to the anaerobic environment.

6. The method of claim 1, additionally comprising adding a dissolved sugar.

7. The method of claim 1, wherein the conditions favor growth of the homofermentative lactic acid bacteria.

8. The method of claim 1, wherein the conditions disfavor growth of bacteria capable of producing CO₂ in the fermentate.

9. The method of claim 1, wherein the conditions are selective for growth of the homofermentative lactic acid bacteria.

10. The method of claim 8, additionally comprising adding a substance selective for growth of the homofermentative lactic acid bacteria to the plant during the fermentation.

11. The method of claim 1, wherein the conditions select against growth of bacteria capable of producing CO₂.

12. The method of claim 1, additionally comprising adding a CO₂ scavenger to the plant during the fermentation.

13. The method of claim 1, additionally comprising adding a bacterium that utilizes CO₂ to the plant during the fermentation.

14. The method of claim 13, wherein the bacterium that utilizes CO₂ converts CO₂ into biomass.

15. The method of claim 1, additionally comprising adding nitrogen fixing, phosphorus solubilizing, and/or potassium solubilizing bacteria to the plant during the fermentation.

16. The method of claim 1, wherein the homofermentative lactic acid bacteria are selected from the group consisting of genus Lactococcus, Enterococcus, Streptococcus, Pediococcus and group I lactobacilli.

17. The method of claim 1, wherein the homofermentative bacteria comprise Latilactobacillus sakei.

18. The method of claim 1, wherein the homofermentative bacteria comprise Lactobacillus lactis.

19. The method of claim 1, wherein the plant comprises a herbaceous plant.

20. The method of claim 1, wherein the plant comprises a vegetable.

21. The method of claim 20, wherein the vegetable comprises a root vegetable.

22. The method of claim 21, wherein the root vegetable comprises roots and leafs/greens.

23. The method of claim 21, wherein the root vegetable has edible greens, (e.g., arracacha, beets, carrots, celeriac, daikons, ginger, leeks, onions, radishes, rutabaga, turmeric, turnips, sweet potatoes).

24. The method of claim 21, wherein the root vegetable is selected from the group consisting of turnips, beets and radishes.

25. The method of claim 21, wherein the root vegetable comprises a true root vegetable (e.g., taproots, tuberous roots) or a non-root vegetable (e.g, bulbs, corms, rhizomes, tubers).

26. The method of claim 25, wherein the taproot comprises beetroot, burdock, carrot, dandelion, parsley, parsnip, radish, rutabaga, sugar beet, turnip, taro or chicory.

27. The method of claim 21, wherein the root vegetable comprises a turnip.

28. The method of claim 21, wherein the root vegetable comprises a daikon radish.

29. The method of claim 25, wherein the turnip comprises Brassica rapa turnips (purple top turnips).

30. The method of claim 1, wherein the plant is grown in soil having a pH less than about 7.0, 6.5, 6.0, 5.5, 5.0 or 4.5.

31. The method of claim 1, wherein the plant is grown in a soil that has:
a. a percent of organic matter greater than 10, 11 or 12;
b. a calcium content greater than 30, 35 or 40 percent; and/or
c. a magnesium content greater than 2.5, 3.0 or 4.0 percent.

32. The method of claim 1, wherein the plant is not washed prior to exposing to the anaerobic environment.

33. The method of claim 1, wherein the plant is shaken to remove soil prior to exposing to the anaerobic environment.

34. The method of claim 1, wherein the plant is chopped, chipped, or shredded prior to exposing to the anaerobic environment.

35. The method of claim 1, wherein the plant is compacted prior to exposing to the anaerobic environment.

36. The method of claim 1, wherein the fermentation is performed in an airtight container.

37. The method of claim 1, wherein the fermentation is performed in a silo, bunker, vessel, or pit.

38. The method of claim 36, wherein the airtight container is vented during the first week of the fermentation.

39. The method of claim 36, wherein the airtight container has a valve that provides for continuous off gassing.

40. The method of claim 1, wherein the fermentation has a duration of at least 10 days.

41. The method of claim 1, wherein the fermentate, at the completion of the fermentation, has a pH of less than about 5.0, 4.5, or 4.0.

42. The method of claim 1, wherein a temperature of an environment immediately surrounding the fermentation is not less than 33° Fahrenheit.

43. The method of claim 1, additionally comprising growing the plant.

44. The method of claim 1, additionally comprising collecting the fermentate.

45. The method of claim 1, additionally comprising collecting the fermentate and effluent.

46. A fermentate produced by the method of claim 1.

47. An organic, plant-based fertilizer produced by the method of claim 1.

48. The fertilizer of claim 47, wherein the plant comprises a root vegetable.

49. The fertilizer of claim 48, wherein the root vegetable comprises roots and greens.

50. The fertilizer of claim 48, wherein the root vegetable comprises a turnip.

51. The fertilizer of claim 47, wherein the fertilizer comprises protein, fixed nitrogen, soluble phosphorus and/or soluble potassium.

52. The fertilizer of claim 47, comprising a crude protein content of at least 10% of dry mass.

53. The fertilizer of claim 47, comprising a fixed nitrogen content (e.g., ammonia) of at least 1.5% of dry mass.

54. The fertilizer of claim 47, comprising a soluble phosphate content of at least 8.5 lbs/1000 gal.

55. The fertilizer of claim 47, comprising a potassium content of at least 8.1 lbs/1000 gal.

56. A method for making an organic fertilizer, comprising:
chopping, chipping or shredding a harvested plant to obtain a chopped/chipped/shredded plant;
fermenting the chipped/shredded plant to produce a fermentate;
wherein homofermentative lactic acid bacteria are in the fermentate.

57. An organic fertilizer, comprising:
a fermented plant that includes protein, fixed nitrogen, soluble phosphorus and soluble potassium;
wherein a crude protein content is at least 10% of dry mass, the fixed nitrogen content (e.g., ammonia) is at least 1.5% of dry mass, the soluble phosphorus content is at least 8.5 lbs/1000 gal., and the soluble potassium content is at least 8.5 lbs/1000 gallon.

58. The organic fertilizer of claim 57, wherein the plant comprises a root vegetable that includes roots and greens.
